(19) United States
(12) Patent Application Publication
(10) Pub. No.: US 2026/0220603 A1
(43) Pub. Date: Jul. 30, 2026

(54) METHOD AND APPARATUS FOR INITIATING COMMUNICATION IN COLLABORATIVE AUTHORING COMMUNITY, METHOD AND APPARATUS FOR RELEASING COLLABORATIVE AUTHORING TASK IN COLLABORATIVE AUTHORING COMMUNITY, ELECTRONIC DEVICE, AND COMPUTER-READABLE STORAGE MEDIUM

(71) Applicant: BEIJING QISUI TECHNOLOGY LTD., Beijing (CN)

(72) Inventors: Congxing OUYANG, Beijing (CN); Qin WU, Beijing (CN)

(21) Appl. No.: 19/146,645

(22) PCT Filed: Jun. 11, 2024
(86) PCT No.: PCT/CN2024/098462

§ 371 Date: Jul. 9, 2025

(30) Foreign Application Priority Data
Jun. 9, 2023 (CN) 202310686955.6

(51) Int. Cl. G06Q 10/101

(52) U.S. Cl. CPC G06Q 10/101

(57) ABSTRACT

The present application provides a method and apparatus for initiating communication in a collaborative authoring community, and an electronic device. The method comprises: acquiring a first collaborative authoring task, wherein the first collaborative authoring task comprises a first process task state diagram, the first process task state diagram comprises one or more first process nodes and one or more first process user sites, the one or more first process user sites belong to the one or more first process nodes, and multiple users include users corresponding to the one or more first process user sites; acquiring a receiver selected in the first process task state diagram by a first collaborative authoring community user; and initiating communication to the receiver, wherein the receiver comprises one or more target user sites, and the one or more first process user sites include the one or more target user sites.

### CROSS-REFERENCE TO RELATED APPLICATION

The present disclosure is filed based on Chinese Patent Application No. 2023106869556, filed on Jun. 9, 2023, and claims the priority to the Chinese patent application, which is incorporated in its entirety herein by reference.

### TECHNICAL FIELD

The present disclosure relates to the technical field of digital information, and in particular to a method and apparatus for initiating communication in a collaborative authoring community, a method and apparatus for releasing a collaborative authoring task in a collaborative authoring community, an electronic device, and a computer-readable storage medium.

### BACKGROUND

Communication is transmission of information from one place to another. Specifically, for communication with an information destination to be preset, a communication process involves the following three elements:
1) a source, to be specific, a source of information, i.e. a sender of the information;
2) a receiver, to be specific, a destination of the information, i.e. a receiver of the information; and
3) a communication channel, i.e. an information transmission channel, or referred to as a transmission medium, through which the information is transmitted.

It can be seen from the above that for the communication with the information destination to be preset, providing addressing information of the receiver for the source is a basic condition to be pre-prepared before the source initiates the communication. Only in this way can the source acquire the addressing information of the receiver. Then, the source can invoke the communication channel to send the information to the receiver, so as to initiate the communication.

In communication applications of telecommunication systems and the Internet, such as telephone calls, QQ, WeChat, and WhatsApp, the source acquires the addressing information of the receiver generally through a telephone number, an Internet protocol (IP) address, a domain name, an email address, a friend name, an address book, etc. In such scenarios, the addressing information of the receiver is provided for the source in a manner of single-point receiver addressing information to single-point source.

In group applications such as a QQ group, a WeChat group, a Tencent meeting, and ZOOM, when joining a group, the source acquires addressing information of each receiver by group. Generally, when acquiring the addressing information of each receiver in a receiver group, the source joins the receiver group and becomes a member of the receiver group simultaneously.

According to collaborative authoring demand of digital work, in order to ensure that a collaborative authoring task is collaboratively authored in a correct order on the basis of perfect basic information, each collaborative authoring task includes a task state diagram. The task state diagram is formed on the basis of the collaborative authoring task and includes at least a plurality of subtasks as nodes in the task state diagram. With development of the collaborative authoring task, the task state diagram will be adjusted dynamically. For example, an increasing number of execution content nodes will be present. Collaborative relations are embodied by topological relations between subtask nodes, between execution content nodes, and between the subtask nodes and the execution content nodes. In the prior art, it is impossible to provide node information of a node associated with the receiver in the task state diagram for the source or provide node information of a node associated with the source in the task state diagram for the receiver.

In essence, the node information of the nodes associated with the receiver and the source respectively in the task state diagram is context information of a task progress. In the prior art, the context information of the task progress cannot be accurately associated with a communication content sent by a user, and thus the communication content lacks accurate context information. In consequence, the communication process is independent of a collaborative authoring progress, which is not conducive to further improvement in collaborative authoring efficiency.

### SUMMARY OF THE INVENTION

A method and apparatus for initiating communication in a collaborative authoring community, an electronic device, and a computer-readable storage medium are provided in examples of the present disclosure. Thus, a communication environment that is closely integrated with collaborative authoring procedures and seamlessly connected with collaborative authoring behaviors is offered to authors of a collaborative authoring task. In such a communication environment, context information of a collaborative authoring task progress is accurately associated with a communication content sent by a user. Thus, a communication process can transfer a collaborative relation corresponding to each communication content, and collaborative authoring efficiency involving man-man collaboration, man-machine collaboration, and machine-machine collaboration can be improved.

The technical solution in the examples of the present disclosure is implemented as follows:

A method for initiating communication in a collaborative authoring community is provided in the examples of the present disclosure. The method is performed by an electronic device. The collaborative authoring community includes a plurality of users. The method includes:
acquiring a first collaborative authoring task, where the first collaborative authoring task includes a first process task state diagram, the first process task state diagram includes one or more first process nodes and one or more first process user sites, the one or more first process user sites belong to the one or more first process nodes, and the plurality of users include users corresponding to the one or more first process user sites;
acquiring a receiver selected in the first process task state diagram by a first collaborative authoring community user; and
initiating communication to the receiver, where the receiver includes one or more target user sites, and the one or more first process user sites include the one or more target user sites.

A method for initiating communication in a collaborative authoring community is provided in the examples of the present disclosure. The method is performed by an electronic device. The collaborative authoring community includes a plurality of users. The method includes:
acquiring a second collaborative authoring task, where the second collaborative authoring task includes a second process task state diagram, the second process task state diagram includes one or more second process nodes and one or more second process user sites, the one or more second process user sites belong to the one or more second process nodes, and the plurality of users include users corresponding to the one or more second process user sites;
acquiring a receiver selected in the second process task state diagram by a second collaborative authoring community user; and
initiating communication to the receiver, where the receiver includes: one or more target user sites, and the one or more second process user sites include the one or more target user sites.

A method for initiating communication in a collaborative authoring community is provided in the examples of the present disclosure. The method is performed by an electronic device. The collaborative authoring community includes a plurality of users. The method includes:
acquiring a current collaborative authoring task, where the current collaborative authoring task includes a current process task state diagram, the current process task state diagram includes one or more current process nodes and one or more current process user sites, the one or more current process user sites belong to the one or more current process nodes, and the plurality of users include users corresponding to the one or more current process user sites;
acquiring a receiver selected in the current process task state diagram by a third collaborative authoring community user; and
initiating communication to the receiver, where the receiver includes: one or more target user sites, and the one or more current process user sites include the one or more target user sites.

A method for releasing a collaborative authoring task in a collaborative authoring community is provided in the examples of the present disclosure. The method is performed by an electronic device. The collaborative authoring community includes a plurality of users, and each user includes a user identifier and user description information. The method includes:
acquiring a preset collaborative authoring task, where the preset collaborative authoring task includes a preset task state diagram, and the preset task state diagram includes one or more subtask nodes; and
generating and releasing a first collaborative authoring task according to the preset collaborative authoring task and the user description information, where the first collaborative authoring task includes a first process task state diagram, the first process task state diagram includes one or more first process nodes and one or more first process user sites, the one or more first process user sites belong to the one or more first process nodes, the plurality of users include users corresponding to the one or more first process user sites, and the one or more first process nodes include the one or more subtask nodes.

A method for releasing a collaborative authoring task in a collaborative authoring community is provided in the examples of the present disclosure. The method is performed by an electronic device. The collaborative authoring community includes a plurality of users, and each user includes a user identifier and user description information. The method includes:
sending a first collaborative authoring task, where the first collaborative authoring task includes a first process task state diagram, the first process task state diagram includes one or more first process nodes and one or more first process user sites, and the one or more first process user sites belong to the one or more first process nodes;
receiving first authoring information of a first author for the first collaborative authoring task, where the first collaborative authoring task includes one or more subtasks, the first authoring information includes a first execution content, the first execution content belongs to a target subtask in the one or more subtasks, and the target subtask is a subtask selected from the one or more subtasks by the first author; and
generating and releasing a second collaborative authoring task according to the first authoring information and the first collaborative authoring task, where the second collaborative authoring task includes a second process task state diagram, the second process task state diagram includes one or more second process nodes and one or more second process user sites, and the one or more second process user sites belong to the one or more second process nodes.

A method for releasing a collaborative authoring task in a collaborative authoring community is provided in the examples of the present disclosure. The method is performed by an electronic device. The collaborative authoring community includes a plurality of users, and each user includes a user identifier and user description information. The method includes:
sending a third collaborative authoring task, where the third collaborative authoring task includes a third process task state diagram, the third process task state diagram includes one or more third process nodes and one or more third process user sites, the one or more third process user sites belong to the one or more third process nodes, and the plurality of users include users corresponding to the one or more third process user sites;
receiving second authoring information of a second author for the third collaborative authoring task, where the third collaborative authoring task includes one or more subtasks, the second authoring information includes a second execution content, the second execution content belongs to a target subtask in the one or more subtasks, and the target subtask is a subtask selected from the one or more subtasks by the second author; and
generating and releasing a fourth collaborative authoring task according to the second authoring information and the third collaborative authoring task, where the fourth collaborative authoring task includes a fourth process task state diagram, the fourth process task state diagram includes one or more fourth process nodes and one or more fourth process user sites, and the one or more fourth process user sites belong to the one or more fourth process nodes.

An apparatus for initiating communication in a collaborative authoring community is provided in the examples of the present disclosure. The collaborative authoring community includes a plurality of users. The apparatus includes:
an acquisition module configured to acquire a first collaborative authoring task, where the first collaborative authoring task includes a first process task state diagram, the first process task state diagram includes one or more first process nodes and one or more first process user sites, the one or more first process user sites belong to the one or more first process nodes, and the plurality of users include users corresponding to the one or more first process user sites;
where the acquisition module is further configured to acquire a receiver selected in the first process task state diagram by a first collaborative authoring community user; and
a communication module configured to initiate communication to the receiver, where the receiver includes one or more target user sites, and the one or more first process user sites include the one or more target user sites.

An apparatus for initiating communication in a collaborative authoring community is provided in the examples of the present disclosure. The collaborative authoring community includes a plurality of users. The apparatus includes:
an acquisition module configured to acquire a second collaborative authoring task, where the second collaborative authoring task includes a second process task state diagram, the second process task state diagram includes one or more second process nodes and one or more second process user sites, the one or more second process user sites belong to the one or more second process nodes, and the plurality of users include users corresponding to the one or more second process user sites;
where the acquisition module is further configured to acquire a receiver selected in the second process task state diagram by a second collaborative authoring community user; and
a communication module configured to initiate communication to the receiver, where the receiver includes: one or more target user sites, and the one or more second process user sites include the one or more target user sites.

An apparatus for initiating communication in a collaborative authoring community is provided in the examples of the present disclosure. The collaborative authoring community includes a plurality of users. The apparatus includes:
an acquisition module configured to acquire a current collaborative authoring task, where the current collaborative authoring task includes a current process task state diagram, the current process task state diagram includes one or more current process nodes and one or more current process user sites, the one or more current process user sites belong to the one or more current process nodes, and the plurality of users include users corresponding to the one or more current process user sites;
where the acquisition module is further configured to acquire a receiver selected in the current process task state diagram by a third collaborative authoring community user; and
a communication module configured to initiate communication to the receiver, where the receiver includes: one or more target user sites, and the one or more current process user sites include the one or more target user sites.

An apparatus for releasing a collaborative authoring task in a collaborative authoring community is provided in the examples of the present disclosure. The collaborative authoring community includes a plurality of users, and each user includes a user identifier and user description information. The apparatus includes:
an acquisition module configured to acquire a preset collaborative authoring task, where the preset collaborative authoring task includes a preset task state diagram, and the preset task state diagram includes one or more subtask nodes; and
a release module configured to generate and release a first collaborative authoring task according to the preset collaborative authoring task and the user description information, where the first collaborative authoring task includes a first process task state diagram, the first process task state diagram includes one or more first process nodes and one or more first process user sites, the one or more first process user sites belong to the one or more first process nodes, the plurality of users include users corresponding to the one or more first process user sites, and the one or more first process nodes include the one or more subtask nodes.

An apparatus for releasing a collaborative authoring task in a collaborative authoring community is provided in the examples of the present disclosure. The collaborative authoring community includes a plurality of users, and each user includes a user identifier and user description information. The apparatus includes:
a sending module configured to send a first collaborative authoring task, where the first collaborative authoring task includes a first process task state diagram, the first process task state diagram includes one or more first process nodes and one or more first process user sites, and the one or more first process user sites belong to the one or more first process nodes;
a reception module configured to receive first authoring information of a first author for the first collaborative authoring task, where the first collaborative authoring task includes one or more subtasks, the first authoring information includes a first execution content, the first execution content belongs to a target subtask in the one or more subtasks, and the target subtask is a subtask selected from the one or more subtasks by the first author; and
a release module configured to generate and release a second collaborative authoring task according to the first authoring information and the first collaborative authoring task, where the second collaborative authoring task includes a second process task state diagram, the second process task state diagram includes one or more second process nodes and one or more second process user sites, and the one or more second process user sites belong to the one or more second process nodes.

An apparatus for releasing a collaborative authoring task in a collaborative authoring community is provided in the examples of the present disclosure. The collaborative authoring community includes a plurality of users, and each user includes a user identifier and user description information. The apparatus includes:
a sending module configured to send a third collaborative authoring task, where the third collaborative authoring task includes a third process task state diagram, the third process task state diagram includes one or more third process nodes and one or more third process user sites, the one or more third process user sites belong to the one or more third process nodes, and the plurality of users include users corresponding to the one or more third process user sites;
a reception module configured to receive second authoring information of a second author for the third collaborative authoring task, where the third collaborative authoring task includes one or more subtasks, the second authoring information includes a second execution content, the second execution content belongs to a target subtask in the one or more subtasks, and the target subtask is a subtask selected from the one or more subtasks by the second author; and
a release module configured to generate and release a fourth collaborative authoring task according to the second authoring information and the third collaborative authoring task, where the fourth collaborative authoring task includes a fourth process task state diagram, the fourth process task state diagram includes one or more fourth process nodes and one or more fourth process user sites, and the one or more fourth process user sites belong to the one or more fourth process nodes.

An electronic device is provided in the examples of the present disclosure. The electronic device includes:
a memory configured to store executable instructions; and
a processor configured to execute the executable instructions stored in the memory, so as to implement the method for initiating communication in a collaborative authoring community or the method for releasing a collaborative authoring task in a collaborative authoring community according to the examples of the present disclosure.

A computer-readable storage medium is provided in the examples of the present disclosure. The computer-readable storage medium has computer-executable instructions stored therein, where the computer-executable instructions, when executed by a processor, cause the processor to implement the method for initiating communication in a collaborative authoring community or the method for releasing a collaborative authoring task in a collaborative authoring community according to the examples of the present disclosure.

The examples of the present disclosure have the beneficial effects as follows:

The one or more target user sites selected in the task state diagram by the collaborative authoring community user are used as the receiver, and the communication to the receiver is initiated. The target user site includes the user identifier of the corresponding user and the node identifier of the node to which the target user site belongs in the task state diagram. In other words, in the solution according to the examples of the present disclosure, the addressing information of the receiver includes two contents. Thus, the communication environment that is closely integrated with the collaborative authoring procedures and seamlessly connected with the collaborative authoring behaviors can be offered to the authors of the collaborative authoring task of digital work. In such a communication environment, the context information of the collaborative authoring task progress is more accurately associated with the communication content sent by the user. Thus, the communication process can transfer the collaborative relation corresponding to each communication content, and the collaborative authoring efficiency involving the man-man collaboration, the man-machine collaboration, and the machine-machine collaboration can be improved.

### BRIEF DESCRIPTION OF THE DRAWINGS

FIG. 1 is a schematic diagram of an architecture of a system 100 for initiating communication in a collaborative authoring community according to an example of the present disclosure;

FIG. 2A is a schematic structural diagram of an electronic device 500 according to an example of the present disclosure;

FIG. 2B is a schematic structural diagram of an electronic device 600 according to an example of the present disclosure;

FIG. 3A-3C are each a schematic flowchart of a method for releasing a collaborative authoring task in a collaborative authoring community according to an example of the present disclosure;

FIG. 4A-4C are each a schematic flowchart of a method for initiating communication in a collaborative authoring community according to an example of the present disclosure;

FIG. 5A-5C are each a first process task state diagram according to an example of the present disclosure;

FIG. 6A is a second process task state diagram according to an example of the present disclosure;

FIG. 6B is a third process task state diagram according to an example of the present disclosure;

FIG. 6C is a third process task state diagram according to an example of the present disclosure;

FIG. 6D is a third process task state diagram according to an example of the present disclosure;

FIG. 6E is a third process task state diagram according to an example of the present disclosure;

FIG. 6F is a third process task state diagram according to an example of the present disclosure;

FIG. 6G is a third process task state diagram according to an example of the present disclosure; and

FIG. 7A-7I are each a schematic diagram of an application scenario of a method for initiating communication in a collaborative authoring community according to an example of the present disclosure.

### DETAILED DESCRIPTION

In order to make the objectives, technical solution, and advantages of the present disclosure clearer, the present disclosure will be further described in detail below in conjunction with the accompanying drawings. Examples described should not be deemed as limiting the present disclosure. All other examples derived by a person of ordinary skill in the art without creative efforts belong to the scope of protection of the present disclosure.

In the following description, reference is made to “some examples” that describes a sub-set of all possible examples. However, it can be understood that “some examples” can indicate a same sub-set or different sub-sets of all the possible examples and can be combined with one another without conflict.

It can be understood that in the examples of the present disclosure, relevant data such as user information (for example, user identity information) is involved. When the examples of the present disclosure are applied to a specific product or technology, user permission or consent needs to be obtained, and collection, use, and processing of the relevant data need to comply with relevant laws, regulations, and standards of relevant countries and regions.

In the following description, the terms “first\second\ . . . ” involved are merely used to distinguish between similar objects, instead of indicating a particular order of the objects. Understandably, the particular order or successive order of “first\second . . . ” can be interchanged where permitted, so that the examples of the present disclosure described herein can be implemented in an order other than those illustrated or described herein.

All the technical and scientific terms used herein have same meanings as those commonly understood by those skilled in the art to which the present disclosure pertains, unless defined otherwise. The terms used herein are merely used to describe the examples of the present disclosure, and are not intended to limit the present disclosure.

Before the examples of the present disclosure are further described in detail, the nouns and terms involved in the examples of the present disclosure are described. The nouns and terms involved in the examples of the present disclosure are applicable to the following explanations.
1) In response to: it is used to indicate a condition or state on which an operation executed depends. One or more operations can be executed in real time or in set delay when the dependency condition or state is satisfied. There is no limitation to a successive execution order of a plurality of operations executed, unless specified otherwise.
2) Task state diagram: it can be a directed acyclic diagram (i.e. a directed diagram without loops), or a directed cyclic diagram (i.e. a directed diagram with loops). For example, with a collaborative authoring task being patent evaluation as an example, the task state diagram can return to a keyword and retrieval strategy node from a technical value evaluation node. For example, when an author 1 notices a problem in keyword retrieval during technical value evaluation for a patent, an author 2 can be asked to re-adjust the keyword and retrieval strategy. The task state diagram can be configured to present authoring information and an authoring process of the collaborative authoring task in a graphical manner, so that the author can intuitively acquire relevant information. It should be noted that a topological structure of the task state diagram can be used for presentation and ensuring that the collaborative authoring task is collaboratively authored in a correct order on the basis of perfect basic information. A collaborative relation is embodied by a topological relation between nodes in the task state diagram. Thus, the task state diagram can be used for man-machine collaboration and machine-machine collaboration (i.e. collaboration between intelligent machine agents), in addition to man-man collaboration.
3) Collaborative authoring task: it is a type of task to be collaboratively authored by a plurality of authors for digital work. The collaborative authoring task includes a plurality of subtasks, where the subtasks indicate tasks having finer granularity, obtained after the collaborative authoring task is decomposed, and to be authored by the authors. For example, when the collaborative authoring task is the patent evaluation, the patent evaluation can be decomposed into six subtasks of keyword and retrieval strategy, relevant comparative documents, technical value evaluation, legal value evaluation, market value evaluation, and an evaluation conclusion. Each subtask is to be authored by an author (including a machine intelligence author) who is skilled in the relevant professional domain. In other words, the collaborative authoring task can be a task to be collaboratively authored by a plurality of authors for the digital work. The collaborative authoring task can include the plurality of subtasks, and each subtask can include subtask description information. The collaborative authoring task can be released by a task releaser according to actual collaborative authoring demand. The author may include, but is not limited to, at least one of an individual user, a group user, an artificial intelligence (AI) user, a machine intelligence user (i.e. a machine intelligence author), etc.; the group user may include, but is not limited to, at least one of an enterprise, an organization, an authoring team, etc.; and each of the AI user and the machine intelligence user may include, but is not limited to, at least one of software, a software platform, a software system, etc. possessing AI or machine intelligence, which is not limited in the examples of the present disclosure.

It should be noted that the subtask can include an atomic type subtask and a framework type subtask. An execution content of the framework type subtask can possess a subordinate subtask. The subordinate subtask can include an atomic type subtask and a framework type subtask. When the subordinate subtask is the framework type subtask, an execution content of the framework type subtask can also possess a subordinate subtask, and so on.

In order to establish a production relation suitable for the information age, for digital collaborative authoring, the task is divided into several subtasks, and procedure management is offered, so that the task is collaboratively authored in the correct order on the basis of perfect basic information. Through digital collaborative authoring, more people and machine intelligent agents who may not know one another, such as a large model software platform, artificial intelligence generated content (AIGC, similar to generative pre-trained transformer (GPT)), can exert their own professional capabilities to efficiently participate in large-scale social production of digital work in their skilled art on the basis of a network. Thus, a digital collaborative authoring system needs to provide a communication environment that is closely integrated with collaborative authoring procedures and seamlessly connected with collaborative authoring behaviors for the authors.

In face of communication service demand from digital collaborative authoring, in a preparation stage before a user in a task group (for example, a first task group or a second task group) initiates communication, for an addressing information pushing solution of the user in the task group, digital collaborative authoring has technical requirements as follows:
1) The task group (for example, the first task group or the second task group) including the task releaser and subtask experts associated with the subtasks needs to be created based on a collaborative authoring task state diagram. Also, authoring behaviors of these authors are in collaborative relations. These collaborative relations are defined by content relations between authoring contents of the authors, including a dependency relation-derivation relation, an inheritance relation-revision relation, an attribution relation-possession relation, etc.

It should be noted that a first process task state diagram can include a task releaser, and/or a template releaser, and/or a platform manager (such as a quality manager, an arbitration committee member, and a professional committee member of the collaborative authoring task), but does not include a subtask execution content author. The second process task state diagram additionally includes the subtask execution content author on the basis of the first process task state diagram.
2) In the preparation stage before the user in the task group (for example, the first task group or the second task group) initiates the communication, addressing information of the user in the task group needs to be pushed to the user in the task group. For example, the task state diagram can be pushed to the user in the task group, where the task state diagram includes the addressing information of the user in the task group, and the addressing information of the user includes node information to which the user belongs, i.e. collaborative relation information.

It should be noted that the action of pushing the task state diagram is to make preparation for a communication process between the users in the task group, and does not belong to the communication process itself. Thus, there is no receiver or source in this case. The concept of the receiver or source indicates an identity that appears only in a process of establishing communication between the users in the task group. In the process of establishing the communication, the user who sends a message in the task group serves as the source, and the user who receives the message serves as the receiver. In a conversation progress of the communication process, when receiving the message, the user in the task group serves as the receiver, and when replying with a new message, the user becomes a source of the new message.

In view of the above, a method and apparatus for initiating communication in a collaborative authoring community, an electronic device, and a computer-readable storage medium are provided in the examples of the present disclosure, so as to solve the problem that address information of a user in a task group established on the basis of a collaborative authoring task state diagram to the user in the task group in the related art. Thus, a communication environment that is closely integrated with collaborative authoring procedures and seamlessly connected with collaborative authoring behaviors is offered to collaborative authors.

An electronic device according to an example of the present disclosure is described below. The electronic device according to the examples of the present disclosure can be implemented as a server or user equipment, or can be collaboratively implemented by the server and the user equipment. The server can be one server configured independently or a server cluster composed of a plurality of servers. During actual implementation, the server can include, but is not limited to, at least one of a physical server, a virtual machine, a cloud server, etc. The user equipment can be one or more of devices having data processing capabilities, such as a notebook computer, a tablet computer, a desktop computer, a mobile device (for example, a mobile phone, a portable video player, a personal digital assistant, a special-purpose messaging device, and a portable game device), and a robot. The method for initiating communication in a collaborative authoring community according to the examples of the present disclosure being collaboratively implemented by the server and the user equipment is described as an example below.

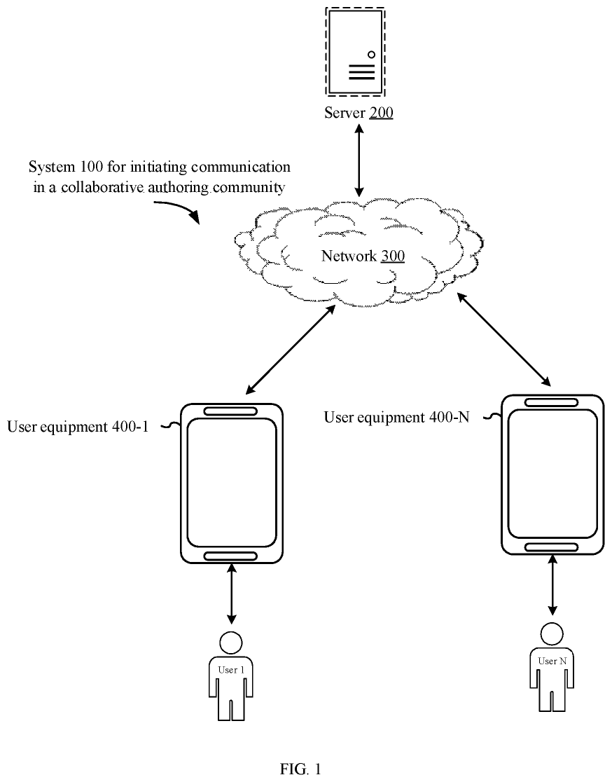

Illustratively, with reference to FIG. 1, a schematic diagram of an architecture of a system 100 for initiating communication in a collaborative authoring community according to an example of the present disclosure is shown. As shown in FIG. 1, the system 100 for initiating communication in a collaborative authoring community includes: a server 200, a network 300, and a plurality of pieces of user equipment, for example, user equipment 400-1 to user equipment 400-N, where N is a positive integer greater than 1. The network 300 may be a local area network, a wide area network, or their combination. The user equipment 400-1 to the user equipment 400-N denote equipment associated with a user 1 to a user N (i.e. a plurality of users included in the collaborative authoring community) respectively. For example, assuming that the user 1 may be a task releaser, a user 2 to the user N may be subtask experts corresponding to a plurality of subtasks respectively. For example, with a first collaborative authoring community user being the user 2 as an example, the user 2 may acquire a first collaborative authoring task through user equipment 400-2, and select a receiver from a first process task state diagram included in the first collaborative authoring task. The receiver is a set of one or more target user sites selected from one or more first process user sites by the user 2. Each user site includes a user identifier of a corresponding user and a node identifier of a first process node to which the user site belongs. In other words, in the technical solution according to the examples of the present disclosure, addressing information of the receiver includes two contents. Then, the user equipment 400-2 may initiate communication to the receiver selected by the user 2.

In some other examples, the method for initiating communication in a collaborative authoring community according to the examples of the present disclosure or may be implemented by the user equipment alone. For example, for a collaborative authoring system implemented in a peer-to-peer (P2P) manner, the above server 200 may be replaced by user equipment of one user, for example, user equipment of the task releaser or user equipment selected according to a P2P rule. In other words, functions implemented by the above server 200 or may be implemented by the user equipment of the task releaser or the user equipment selected according to the P2P rule, which is not specifically limited in the examples of the present disclosure.

It should be noted that the server 200 in FIG. 1 may be an independent physical server, a server cluster or distributed system composed of a plurality of physical servers, or a cloud server that provides basic cloud computation services such as a cloud service, a cloud database, cloud computation, a cloud function, cloud storage, a network service, cloud communication, a middleware service, a domain name service, a security service, a content delivery network (CDN), big data, and an artificial intelligence platform. The user equipment 400-1 to the user equipment 400-N may be, but are not limited to, smart phones, tablet computers, notebook computers, desktop computers, smart speakers, smart watches, vehicle-mounted terminals, robots, physical user equipment, physical user equipment clusters or distributed systems offering machine intelligence, etc. The user equipment (for example, the user equipment 400-1 to the user equipment 400-N) and the server 200 may be connected directly or indirectly in a wired or wireless communication manner, which is not limited in the examples of the present disclosure.

In addition, it should also be noted that in a scenario involving man-machine collaboration or machine-machine collaboration, the above user associated with the user equipment may be a machine intelligence user or an AI user. Each of the AI user and the machine intelligence user may include, but is not limited to, at least one of software, a software platform, a software system, etc. possessing AI or machine intelligence, which is not limited in the examples of the present disclosure. The author may include, but is not limited to, at least one of an individual user, a group user, an AI user, a machine intelligence user, a machine intelligence author, etc.; the group user may include, but is not limited to, at least one of an enterprise, an organization, an authoring team, etc.; and each of the AI user and the machine intelligence user may include, but is not limited to, at least one of software, a software platform, a software system, etc. possessing AI or machine intelligence, which is not limited in the examples of the present disclosure.

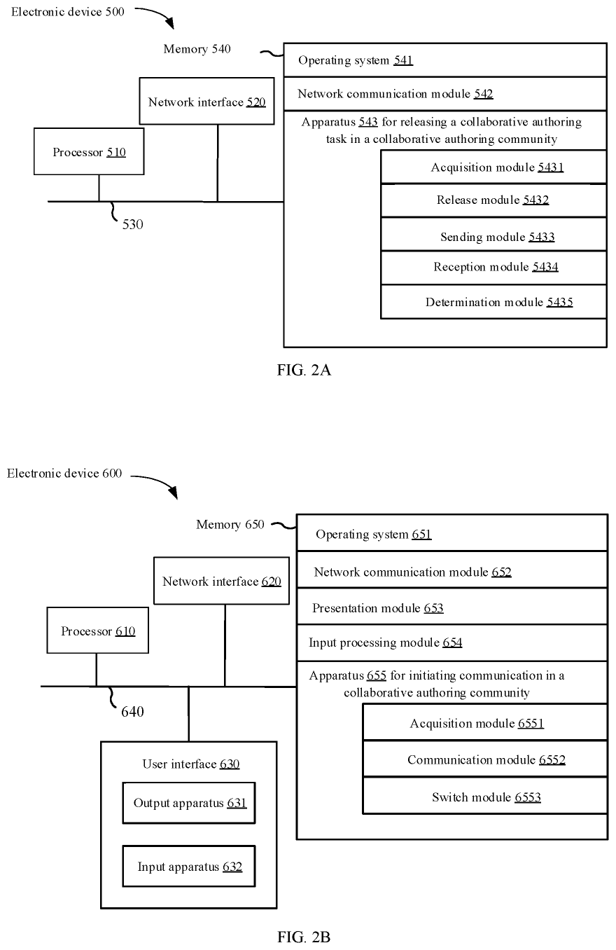

A structure of the electronic device according to the examples of the present disclosure continues to be described below. With the electronic device being the server as an example, with reference to FIG. 2A, a schematic structural diagram of an electronic device 500 according to an example of the present disclosure is shown. As shown in FIG. 2A, the electronic device 500 includes: at least one processor 510, a memory 540, and at least one network interface 520. Various components in the electronic device 500 are coupled together through a bus system 530. It can be understood that the bus system 530 is configured to implement connected communication between these components. The bus system 530 further includes a power bus, a control bus, and a state signal bus, in addition to a data bus. However, for clarity of description, various buses are marked as the bus system 530 in FIG. 2A.

The processor 510 may be an integrated circuit chip having signal processing capabilities, such as a general-purpose processor, a digital signal processor (DSP), another programmable logic device, discrete gate or transistor logic device, a discrete hardware component, etc. The general-purpose processor may be a microprocessor, any conventional processor, etc.

The memory 540 may be a removable memory, a non-removable memory, or their combination. The illustrative hardware device includes a solid state memory, a hard disk drive, an optical disk drive, etc. The memory 540 optionally includes one or more storage devices physically away from the processor 510.

The memory 540 includes a volatile memory or a non-volatile memory, or may include the volatile memory and the non-volatile memory. The non-volatile memory may be a read only memory (ROM), and the volatile memory may be a random access memory (RAM). The memory 540 described in the examples of the present disclosure is intended to include any suitable type of memory.

In some examples, the memory 540 may store data to support various operations. Instances of these data include programs, modules, data structures, or their sub-sets or supersets, which are illustratively described below.

The memory includes: an operating system 541 including a system program configured to process various basic system services and execute hardware-relevant tasks, such as a framework layer, a core library layer, and a drive layer, and configured to implement various basic services and process hardware-based tasks; and a network communication module 542 configured to reach other computation devices via one or more (wired or wireless) network interfaces 520, where the illustrative network interface 520 includes: a Bluetooth interface, a wireless fidelity (WiFi) interface, a universal serial bus (USB) interface, etc.

In some examples, an apparatus according to the examples of the present disclosure may be implemented through software. FIG. 2A shows an apparatus 543 used for releasing a collaborative authoring task in a collaborative authoring community and stored in the memory 540. The apparatus may be software in a form of a program, a plug-in, etc., and includes the following software modules: an acquisition module 5431, a release module 5432, a sending module 5433, a reception module 5434, and a determination module 5435. These modules are logical, and thus may be randomly combined or further divided according to the functions to be implemented.

A structure of the electronic device according to the examples of the present disclosure continues to be described below. With the electronic device being the user equipment as an example, with reference to FIG. 2B, a schematic structural diagram of an electronic device 600 according to an example of the present disclosure is shown. The electronic device 600 includes: a processor 610, a network interface 620, a user interface 630, a bus system 640, and a memory 650. The user interface 630 includes one or more output apparatuses 631 that can present media contents, for example, one or more loudspeakers and/or one or more visual display screens. The user interface 630 further includes one or more input apparatuses 632, including a user interface component that facilitates user input, such as a keyboard, a mouse, a microphone, a touch display screen, a camera, and another input button and control. The memory 650 includes: an operating system 651; a network communication module 652; a presentation module 653 configured to display information via one or more output apparatuses 631 (for example, a display screen and a loudspeaker) associated with the user interface 630, such as a user interface configured to operate a peripheral device and display contents and information; an input processing module 654 configured to detect one or more user inputs or interactions from the one or more input apparatuses 632; and an apparatus 655 configured to translate the input or interaction detected and initiate communication in the collaborative authoring community. Software modules in the apparatus 655 for initiating communication in a collaborative authoring community stored in the memory 650 include: an acquisition module 6551, a communication module 6552, and a switch module 6553. These modules are logical, and thus may be randomly combined or further divided according to the functions to be implemented.

It should be noted that machine intelligence user equipment is probably not provided with the “presentation module 653” shown in FIG. 2B. The user equipment of the AI user or the machine intelligence user may read, write, modify, maintain a task state diagram, etc. of a collaborative authoring task in its data memory. Thus, the memory further stores various data of the collaborative authoring task, in addition to the operating system.

In order to facilitate easier understanding of the method for initiating communication in a collaborative authoring community according to the examples of the present disclosure, an implementation architecture of a collaborative authoring system is described first.

The collaborative authoring system according to the examples of the present disclosure may include various roles as follows:
1) A template maker who may make and release a task template in an expert pool where the template maker is located. If belonging to a plurality of different expert pools, the template maker (i.e. an expert) needs to select the expert pool for releasing the task template. A task template released in a partner-owned expert pool is saved in a database owned by a partner-owned service system. A task template released in a public expert pool is saved in a public database.

It should be noted that an expert pool in the collaborative authoring system according to the examples of the present disclosure may include: a public expert pool operated by a public service system and an ecological partner-owned expert pool operated by an ecological partner-owned service system, where client decentralized applications (DApps) may be built in user terminals of the public expert pool and the ecological partner-owned expert pool. The client DApp saves and uses a user private key through secure means. A user public key is publicly released to others. The system takes the user private key as the proof of an identity and rights of a user. Also, the system may update the user private key through security means and release a corresponding user public key to others according to management demand. It should be noted that for a user terminal of a partner x-owned expert pool joining the system, a user in the partner x-owned expert pool or may be identified and authenticated through an original identity system, in addition to building in a client DApp as that for a user in the public expert pool.

The collaborative authoring system further includes: 2) A task releaser who may preset and release the collaborative authoring task in the expert pool where the task releaser is located. If belonging to a plurality of expert pools, the user needs to select the expert pool for setting and releasing the task. The task released in the partner-owned expert pool is mainly collaboratively authored in the partner-owned expert pool, and relevant data are mainly saved in the database owned by the partner-owned service system. The task released in the public expert pool is collaboratively authored in the public expert pool, and relevant data are saved in the public database.

The collaborative authoring system further includes: 3) A subtask author who may include a framework type subtask author and an atomic type subtask author. A subtask author of the task released in the partner-owned expert pool mainly carries out collaborative authoring in the partner-owned expert pool, and relevant data are mainly saved in the database owned by the partner-owned service system. A subtask author of the task released in the public expert pool carries out collaborative authoring in the public expert pool, and relevant data are saved in the public database.

The collaborative authoring system further includes: 4) A question solver. Each expert in various types of expert pools may participate in question resolution in the expert pool where each expert is located.

The collaborative authoring system according to the examples of the present disclosure may provide two types of services including an expert pool operation service and a document operation service for public Internet users.

Illustratively, the public Internet users may select and register with special committees (multiple options are allowed) that they belong, so as to apply for entry into the public expert pool through the “expert pool operation service” provided by a service capability base. After being reviewed and approved by relevant special committees of the expert pool, the users are approved to enter the pool.

Illustratively, the public Internet users may use the public document data service including a global document data retrieval engine service, document browsing and downloading in a document database, etc. through the “document operation service” provided by the service capability base. The scope of document data includes original documents and data generated by the collaborative authoring system, paid documents and data of external copyrights, and free documents and data. The types of the documents and data include, but are not limited to, at least one of reports, patents, standards, papers, books, web pages, etc.

In addition, the collaborative authoring system may maintain and process a variety of data, including service data, user data, transaction data, etc. The service data are data relevant to digital work generated through collaborative authoring, such as at least one of a task template data packet, a task data packet, an execution content data packet, a question resolution data packet, etc. The user data are user-relevant data, such as a user name, user identity information, user account information, user credit level, etc. The transaction data are transaction-relevant data, such as task reward account data, digital work copyright income account data, a task reward amount, a template account split ratio, a template account split amount, subtask account split ratio, a subtask account split amount, a work owner copyright income account split ratio, task completion effect evaluation, a question resolution reward, etc.

The method for releasing a collaborative authoring task in a collaborative authoring community and the method for initiating communication in a collaborative authoring community according to the examples of the present disclosure will be described in detail below according to a service flow of establishing end-to-end communication in the collaborative authoring system of the digital work.

In some examples, the collaborative authoring system according to the examples of the present disclosure may have a description information library. Description information may be configured to point to each collaborative authoring task and its subtasks, and a professional domain of each user and its various sub-divided branches.

In some examples, the collaborative authoring system according to the examples of the present disclosure may have a domain tag library. Tags are configured to point to various professional domains and their various sub-divided branches. These tags may also carry the description information that is configured to describe the connotations of the tags and a relation between the tags.

Illustratively, when registering with or logging in to the collaborative authoring system according to the examples of the present disclosure, the user needs to perfect user information, such as user description information. Moreover, each user may obtain own unique identity document (ID) that is set by each user or assigned by the system. Also, the user description information or domain tags may also be added, deleted, or revised by the machine intelligence software, platform, or system based on user-relevant data according to algorithms.

First, a process of releasing a first collaborative authoring task in the collaborative authoring community is described below, where the collaborative authoring community may include a plurality of users, and each user may include a corresponding user identifier and corresponding user description information.

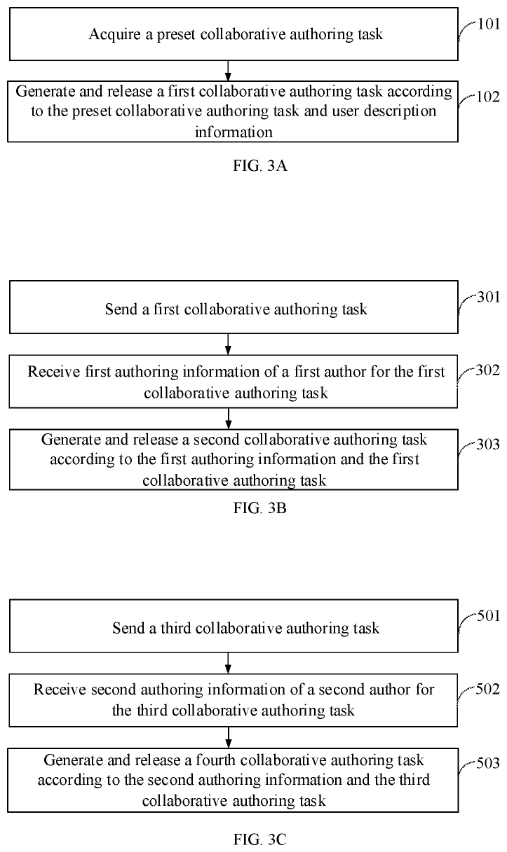

Illustratively, with reference to FIG. 3A, a schematic flowchart of a method for releasing a collaborative authoring task in a collaborative authoring community according to an example of the present disclosure is shown, and the method is described in conjunction with steps shown in FIG. 3.

Step 101, a preset collaborative authoring task is acquired.

Herein, the preset collaborative authoring task may include a preset task state diagram, and the preset task state diagram may include one or more subtask nodes.

In some examples, the preset collaborative authoring task may include one or more subtasks, and each subtask may include subtask description information. The preset collaborative authoring task may be released by a task releaser according to actual collaborative authoring demand. An author may include, but is not limited to, at least one of an individual user, a group user, an artificial intelligence (AI) user, a machine intelligence user, a machine intelligence author, etc.; the group user may include, but is not limited to, at least one of an enterprise, an organization, an authoring team, etc.; and each of the AI user and the machine intelligence user may include, but is not limited to, at least one of software, a software platform, a software system, etc. possessing AI or machine intelligence, which is not limited in the examples of the present disclosure.

It should be noted that the subtask description information involved in the examples of the present disclosure may be information of a specific item and/or field, or information including a plurality of items and/or fields, which is not specifically limited in the examples of the present disclosure. In a case where the subtask description information includes the information of the plurality of items and/or fields, the subtask description information may include one or more of the following information: a subtask name of the subtask, a description information field of the subtask, keywords corresponding to the subtask, and description information of the preset collaborative authoring task to which the subtask belongs. In addition, in a case where the subtask is a subordinate subtask, the subtask description information may further include description information of a superior subtask to which the subtask belongs. In a case where the subtask is revised from a previous subtask, the subtask description information may further include description information of the previous subtask inherited by the subtask, node relation information of the subtask in the task state diagram, etc.

In addition, it should also be noted that the type of the digital work authorable through the collaborative authoring task is not limited in the examples of the present disclosure. The digital work generally indicates digital work having structured information.

Illustratively, the preset collaborative authoring task may be patent evaluation, industry analysis, industry research, technical evaluation, virtual metaverse park construction, collaborative company research report authoring, a construction project environment evaluation report, a theme film or drama, etc. Authored digital work corresponds to a patent evaluation report, an industry analysis report, an industry research report, a technical evaluation report, a virtual metaverse park, a company research report, a construction project environment evaluation report, the theme film or drama, etc. respectively. The preset collaborative authoring task includes a plurality of subtasks, and the subtasks indicate tasks having finer granularity, obtained after the preset collaborative authoring task is decomposed, and to be authored by the author. For example, when the preset collaborative authoring task is the patent evaluation, the patent evaluation may be decomposed into six subtasks of a keyword and retrieval strategy, a relevant comparative document, technical value evaluation, legal value evaluation, market value evaluation, and an evaluation conclusion. Each subtask is to be authored by the author who is skilled in the relevant professional domain. For another example, when the preset collaborative authoring task is the collaborative company research report authoring task, the collaborative company research report authoring task may be decomposed into company condition research, attributed industry research, industry analysis, competitiveness analysis, profit prediction and investment suggestions, risk prompts, report key points, etc.

It should be noted that generally, when the preset collaborative authoring task is acquired, a task identifier of the preset collaborative authoring task may also be acquired. The task identifier may be a globally unique identifier generated when the preset collaborative authoring task is released. The task identifier uniquely corresponds to the preset collaborative authoring task, so that data confusion is avoided when the preset collaborative authoring tasks have identical contents.

In some examples, the task releaser may preset and release the preset collaborative authoring task in the expert pool where the task releaser is located. If belonging to a plurality of expert pools, the task releaser also needs to select one or more expert pools for releasing the task. For example, a preset collaborative authoring task released in the partner-owned expert pool is mainly collaboratively authored in the partner-owned expert pool, and relevant data are mainly saved in the database owned by the partner-owned service system. A preset collaborative authoring task released in the public expert pool is collaboratively authored in the public expert pool, and relevant data are saved in the public database of the public service system.

In some other examples, when the preset collaborative authoring task (referred to as a task for short) is to be released, the task may further include task description information or domain tag list, where the task domain tag list includes one or more tags. The task description information or domain tag list may be configured to indicate the domain to which the task belongs and/or the domain involved. Each subtask of the task may also include subtask description information or domain tag list, where the subtask domain tag list includes one or more tags. The subtask description information or domain tag list is configured to indicate the domain to which the subtask belongs, and/or the domain involved, and/or a professional orientation, and/or a scenario orientation.

Illustratively, the task description information or domain tag list may form an initial value in template description information of the task template. The task releaser may further add, delete, or revise the task description information or the task domain tag list through task setting information. Each subtask description information or domain tag list may form an initial value in the subtask description information of the task template. The task releaser may further add, delete, or revise each subtask description information or the subtask domain tag list encompassed in the subtask description information through task setting information. Alternatively, the machine intelligence software or platform or system or may obtain the professional domains involved in the task and the subtasks and various sub-divided branches according to algorithms by reading the task template, task description information, task setting information, and subtask description information, or add, delete, or revise the task domain tag and the subtask domain tags.

In addition, when to be released, the preset collaborative authoring task may further include a credit demand parameter. For example, the task releaser may specify that only an expert having a high credit rating (i.e. having a credit rating greater than a rating threshold) can claim relevant subtasks.

Step 102, a first collaborative authoring task is generated and released according to the preset collaborative authoring task and user description information.

Herein, the first collaborative authoring task may include a first process task state diagram, where the first process task state diagram may include one or more first process nodes and one or more first process user sites, the one or more first process user sites belong to the one or more first process nodes, the plurality of users include users corresponding to the one or more first process user sites, and the one or more first process nodes include the one or more subtask nodes.

In some examples, each first process user site may include a corresponding node identifier; and each first process user site may include: a user identifier of a user corresponding to the first process user site and a node identifier of a first process node to which the first process user site belongs. In other words, in the technical solution according to the examples of the present disclosure, the user site includes two contents.

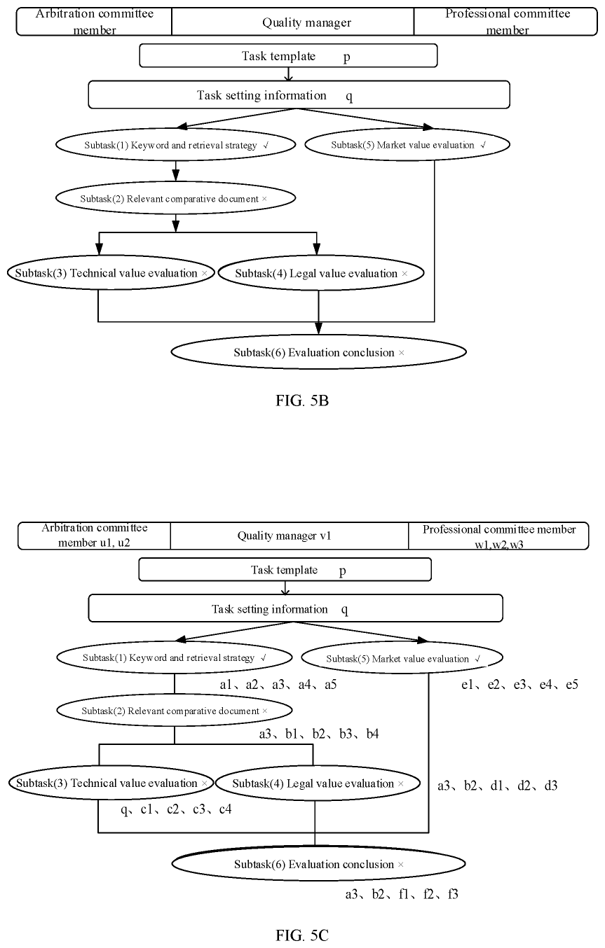

Illustratively, with the first collaborative authoring task being a patent evaluation task as an example, with reference to FIG. 5A, a first process task state diagram according to an example of the present disclosure is shown, where all subtasks in the task template are atomic type subtasks. As shown in FIG. 5A, Subtask (1) and Subtask (5), independent of other subtasks, can be directly authored and preset to an authorable state, and other subtasks are preset to a non-authorable state. The subtasks in the authorable state are indicated by a symbol V and can be selected by the author and input with authoring information. The subtasks in the non-authorable state are indicated by a symbol X and cannot be selected by the author or input with authoring information.

In some other examples, the above one or more first process nodes may further include a platform node (for example, nodes formed by a quality manager, a professional committee member, an arbitration committee member, etc. included in the first collaborative authoring task). The platform node is configured to provide management and/or a service for a platform.

Illustratively, with the first collaborative authoring task being the patent evaluation task as an example continuously, with reference to FIG. 5B, a first process task state diagram according to an example of the present disclosure is shown. As shown in FIG. 5B, the first process task state diagram may further include platform nodes formed by an arbitration committee member, a quality manager, and a professional committee member, etc. of the task. In addition, a task setting information node in the first process task state diagram is associated with task releaser identity information q, and/or a task template node in the first process task state diagram is associated with template releaser identity information p. In other words, when the task releaser releases the first collaborative authoring task, an initial value of a first task group may be generated. In the initial value of the first task group, group members may include: a task releaser q associated with the task setting information node in the first process task state diagram, and/or a template releaser p associated with the task template node, the arbitration committee member, the quality manager, and the professional committee member.

It should be noted that the platform nodes such as the quality manager, the professional committee member, and the arbitration committee member may be matched with expert users according to the description information and/or domain tag list of the collaborative authoring task, credit demand of the task, and expert description information and/or expert domain tag list and credit evaluation parameters of a quality management expert group, a professional committee, an arbitration committee in the expert pool for releasing the task. According to a descending order of matching degrees, several experts having highest-ranking matching degrees with the platform node, such as the top 5 expert users, are obtained. These expert users are associated with the corresponding platform nodes and referred to as platform experts.

The platform experts may include, but are not limited to, at least one of an individual user, a group user, an artificial intelligence (AI) user, a machine intelligence user, etc.; the group user may include, but is not limited to, at least one of an enterprise, an organization, a team, etc.; and each of the AI user and the machine intelligence user may include, but is not limited to, at least one of software, a software platform, a software system, etc. possessing AI or machine intelligence, which is not limited in the examples of the present disclosure.

In addition, it should be noted that the template maker, the task releaser, the collaborative author, the arbitration committee member, the quality manager, the professional committee member, etc. are merely user roles in a collaborative authoring process of the digital work. The template maker indicates a user role who makes the template. The task releaser indicates a user role who releases the collaborative authoring task. The collaborative author indicates a role who authors the collaborative authoring task released. The quality manager indicates a user role who offers a quality management service on a quality of the collaboratively-authored work and belongs to the quality management committee or the quality management expert group. The professional committee member indicates a user role who offers a supporting or counseling service on the problems in the professional domain involved in collaborative authoring and belongs to the professional committee or a professional expert group. The arbitration committee member indicates a user role who offers an arbitration service on controversial matters involved in collaborative authoring and belongs to the arbitration committee or an arbitration expert group. For the platform users such as the quality manager, the professional committee member, and arbitration committee member, the system matches the platform node with the expert users according to the task description information and/or domain tag list and the credit demand of the task, and expert description information and/or expert domain tag list and credit evaluation parameters of the quality management committee, the professional committee, and the arbitration committee in the expert pool releasing the task. According to a descending order of the matching degrees, several experts having highest-ranking matching degrees with the platform node, such as the top 5 expert users, are obtained. These expert users are associated with the corresponding platform nodes by the system and referred to as platform experts.

In addition, each of the template maker, the task releaser, the collaborative author, the quality manager, the professional committee member, and the arbitration committee member may include, but is not limited to, at least one of an individual user, a group user, an AI user, a machine intelligence user, etc., which is not limited in the examples of the present disclosure. During implementation, no matter whether the users are human individuals or groups, AI software, AI platforms, or AI systems, they may be registered as the users of the collaborative authoring system according to a unified mechanism, so as to participate in the collaborative authoring process as the above user roles. In some embodiments, the AI user/machine intelligence user such as the AI software, the AI platform, and the AI system may have a dedicated user account set through a specific registration mechanism, so as to participate in the collaborative authoring process as the above user role. The following examples are described with the individual user participating in collaborative authoring as an example. Under such an inventive concept, it can be conceived that the group user, the AI user, and the machine intelligence user participate in collaborative authoring without creative efforts. In some examples, at least some of the plurality of subtask nodes are associated with subtask experts, where the subtask experts are candidate authors of subtasks corresponding to the subtask nodes.

In some examples, before releasing the first collaborative authoring task, the server may further execute the following processing: for at least one first process node of the one or more first process nodes, a first process user site associated with the at least one first process node is determined in at least one of the following ways: the first process user site associated with the at least one first process node is determined by direct assigning; and the first process user site associated with the at least one first process node is determined by intelligent matching.

Illustratively, the above preset collaborative authoring task may include one or more subtasks, and each subtask may include corresponding subtask description information. When at least one first process node is at least one subtask node, the step that the first process user site associated with the at least one first process node is determined by intelligent matching may be implemented in the following way: processing is performed on each subtask node as follows: the subtask description information of a subtask corresponding to the subtask node is matched with the user description information of each of the plurality of users, so as to obtain at least one user having a highest-ranking matching degree; and the first process user site associated with the subtask node is determined according to the at least one user having a highest-ranking matching degree.

It should be noted that a same user in the collaborative authoring community may include a plurality of user sites. For example, when being the quality manager and a subtask expert of one subtask, one user may have two different user sites simultaneously.

In some other examples, in the first process task state diagram, subtask nodes corresponding to subtasks that do not depend on other subtasks and can be directly authored (i.e. the subtasks currently in an authorable state) in the plurality of subtasks may be associated with the subtask experts at first. Subtask nodes corresponding to subtasks that can be authored only by depending on other subtasks (i.e. the subtask currently in a non-authorable state) may not be associated with the subtask experts in the first process task state diagram. Certainly, all the subtask nodes or may be associated with corresponding subtask experts in the first process task state diagram, which is not specifically limited in the examples of the present disclosure.

It should be noted that the subtask herein may further include a subordinate subtask possessed by the framework type subtask, and the subtask expert may further include a subordinate subtask expert, i.e. a subtask expert associated with the subordinate subtask possessed by the framework type subtask.

In some examples, the subtask expert associated with the subtask node or may be determined in the following domain tag-free manner: machine intelligence software having a learning capability is pre-trained with big data encompassing description information relevant to the task and the subtask, expert description information, and subtask and expert matching effect information. When it is necessary to search for a suitable subtask expert for the subtask node, the description information relevant to the subtask node is provided for pre-trained machine intelligence software. The machine intelligence software selects several suitable candidate authors from an expert library, so as to determine the subtask expert associated with the subtask node.

Illustratively, for each subtask node, the subtask may be matched with the expert users according to the subtask description information and/or domain tag list, the task description information and/or domain tag list and credit demand parameters of the task to which the subtask belongs, and description information and/or expert domain tag list and credit evaluation parameters of each expert user in the expert pool for releasing the task. According to a descending order of the matching degrees, several expert users having highest-ranking matching degrees with the subtask, such as the top 5 expert users, are obtained. These expert users are associated with the corresponding subtask nodes and referred to as subtask experts.

It should be noted that the above expert user may include, but is not limited to, at least one of an individual user, a group user, an AI user, a machine intelligence user (i.e. a machine intelligence author), etc.; the group user may include, but is not limited to, at least one of an enterprise, an organization, an authoring team, etc.; and each of the AI user and the machine intelligence user may include, but is not limited to, at least one of software, a software platform, a software system, etc. possessing AI or machine intelligence, which is not limited in the examples of the present disclosure.

Illustratively, with the first collaborative authoring task being the patent evaluation task as an example continuously, with reference to FIG. 5C, a first process task state diagram according to an example of the present disclosure is shown. As shown in FIG. 5C, after the above matching operation, an extended value of the first task group may be generated. In the extended value of the first task group, the group members may include: a task releaser q associated with a task setting information node in the first process task state diagram, and/or a template releaser p associated with a task template node, subtask experts associated with each subtask node (for example, subtask experts a1, a2, a3, a4, and a5 associated with the subtask (1)), and a platform expert associated with each platform node (for example, a platform expert v1 associated with the quality manager).

In some examples, the first process task state diagram may include a first task group, where the first task group may include a plurality of users associated with a plurality of first process nodes respectively. The plurality of first process nodes may include: a task setting information node and at least some subtask nodes. Thus, after the first collaborative authoring task is generated, the first process task state diagram included in the first collaborative authoring task may also be pushed to the users in the first task group.

It should be noted that pushing the first process task state diagram is not a group communication action, and thus can be merged instead of being performed separately according to the first task group. For example, if the task releaser q and one subtask expert q associated with one subtask node subtask (3) are a same user q, only one first process task state diagram needs to be pushed to the user q.

Illustratively, with at least some subtask nodes being subtask nodes corresponding to subtasks that do not depend on other subtasks and can be directly authored in a plurality of subtasks as an example, the first task group may include only the following users: the task releaser associated with the task setting information node, and subtask experts associated with the subtask nodes corresponding to the subtasks that do not depend on other subtasks and can be directly authored in the plurality of subtasks. For example, with the collaborative authoring task being the patent evaluation as an example, the patent evaluation may be decomposed into six subtasks of a keyword and retrieval strategy, a relevant comparative document, technical value evaluation, legal value evaluation, market value evaluation, and an evaluation conclusion. If the keyword and retrieval strategy and the market value evaluation are the subtasks that do not depend on other subtasks and can be directly authored in the six subtasks, the first task group may include only the following users: the task releaser, a subtask expert associated with a keyword and retrieval strategy node, and a subtask expert associated with a market value evaluation node.

It should be noted that the first task group in the examples of the present disclosure may be a structured task group. In other words, members in the first task group have structured features. The structured features of the members in the first task group are associated with a topological structure of the task state diagram of the collaborative authoring task to which the task group belongs.

For example, for the extended value of the first task group of the first collaborative authoring task, the group members include: the task releaser associated with the task setting information node in the first process task state diagram and/or the template releaser associated with the task template node, subtask experts associated with each subtask node, and a platform expert associated with each platform node. If the task releaser q and one subtask expert q associated with the subtask node subtask (3) are a same user, for a non-structured task group, the members embodied in the group will merge these two roles into one user q. However, for the structured first task group in the examples of the present disclosure, even if the task releaser q and one subtask expert q are the same user, the first task group belonging to the collaborative authoring task should still embody two members. One member is associated with the task setting information node in the first process task state diagram and acts as the task releaser, with a corresponding user site [task releaser, q]. The other member is associated with the subtask node subtask (3) in the first process task state diagram and acts as the subtask expert, with a corresponding user site [subtask (3), q]. When one user (for example, the quality manager v1) sends a message to the communication group in the task state diagram, if the communication group includes the task releaser and the subtask expert, even if the task releaser and the subtask expert are the same user, the message belongs to two receivers, including an inbox of the user site [task releaser, q] of the task releaser q associated with the task setting information node and an inbox of the user site [subtask (3), q] of the subtask expert q associated with the subtask node subtask (3) separately.

In some other examples, if one user (for example, the quality manager v1) selects to send a message to all subtask experts included in the communication group in the first process task state diagram, in a case where the communication group includes the task releaser and the subtask expert, the message belongs to only one receiver even if the task releaser and one subtask expert are the same user. In other words, the inbox of the user site [subtask (3), q] of the subtask expert q associated with the subtask node subtask (3) receives the message, while the inbox of the user site [task releaser, q] of the task releaser q associated with the task setting information node will not receive the message.

A process of initiating communication in a collaborative authoring community based on a first process task state diagram included in a first collaborative authoring task is described below, where the collaborative authoring community may include a plurality of users.

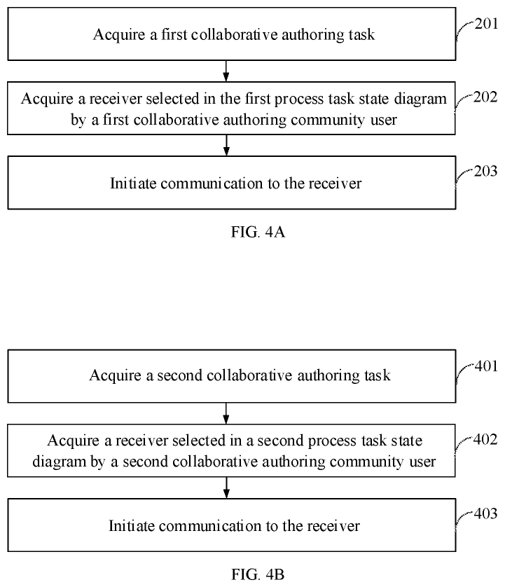

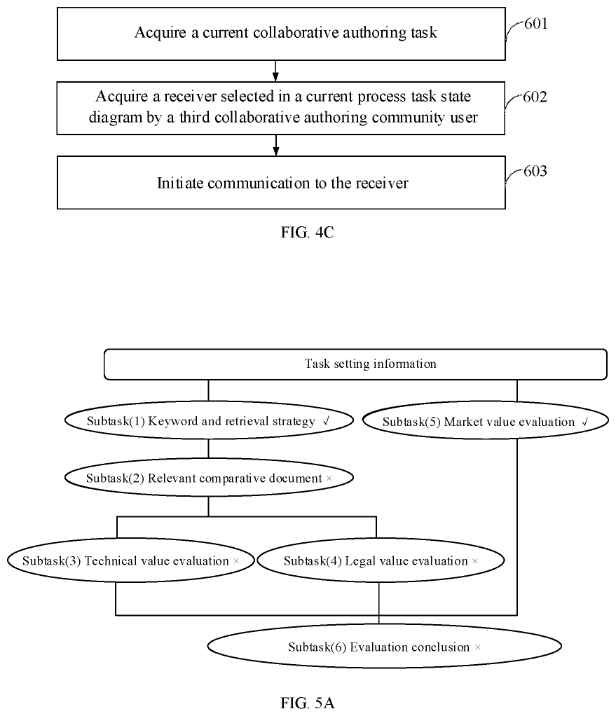

Illustratively, with reference to FIG. 4A, a schematic flowchart of a method for initiating communication in a collaborative authoring community according to an example of the present disclosure is shown, and the method is described in conjunction with steps shown in FIG. 4A.

Step 201, a first collaborative authoring task is acquired.

Herein, the first collaborative authoring task may include a first process task state diagram, the first process task state diagram may include one or more first process nodes and one or more first process user sites, the one or more first process user sites belong to the one or more first process nodes, and the plurality of users include users corresponding to the one or more first process user sites.

In some examples, each user in the collaborative authoring community may include a corresponding user identifier; each first process node may include a corresponding node identifier; and each first process user site may include: a user identifier of a user corresponding to the first process user site and a node identifier of a first process node to which the first process user site belongs.

In some other examples, the above one or more first process nodes may include platform nodes (for example, nodes formed by a quality manager, a professional committee member, an arbitration committee member, etc.). The platform nodes are configured to provide management and/or services for a platform.

Step 202, a receiver selected in the first process task state diagram by a first collaborative authoring community user is acquired.

In some examples, step 202 may be implemented in the following way: in response to a selection operation of selecting at least one first process node in the first process task state diagram by the first collaborative authoring community user, at least one first process user site associated with the selected at least one first process node is taken as the receiver.

Illustratively, the step that in response to a selection operation of selecting at least one first process node in the first process task state diagram by the first collaborative authoring community user, at least one first process user site associated with the selected at least one first process node is taken as the receiver may be implemented in the following way: in response to determining that the at least one first process node is selected in the first process task state diagram by the first collaborative authoring community user, all first process user sites associated with the selected at least one first process node are acquired; and in response to determining that at least one first process user site is selected from all the associated first process user sites by the first collaborative authoring community user, the selected at least one first process user site is taken as the receiver.

It should be noted that the “association” relation in the examples of the present disclosure is equivalent to the “attribution-possession” relation. The two phrases have a same meaning, and thus are not distinguished from each other in the examples of the present disclosure.

Illustratively, when the first process node to which a target user site belongs includes a subtask node, the step that in response to a selection operation of selecting at least one first process node in the first process task state diagram by the first collaborative authoring community user, at least one first process user site associated with the selected at least one first process node is taken as the receiver may be implemented in the following way: in response to determining that a first subtask node is selected in the first process task state diagram by the first collaborative authoring community user, at least one communication action option associated with the first subtask node is acquired, where each communication action option corresponds to at least one subtask node; and in response to determining that a first communication action option is selected from the at least one communication action option by the first collaborative authoring community user, at least one first process user site associated with a subtask node corresponding to the first communication action option is taken as the receiver.

In some other examples, following the above instance, in response to determining that the first communication action option is selected from the at least one communication action option by the first collaborative authoring community user, the following processing may also be executed: the subtask node corresponding to the first communication action option is switched from a first scenario mode to a second scenario mode, so as to indicate that the subtask node corresponding to the first communication action option is currently in a selected state, where the second scenario mode is different from the first scenario mode.

It should be noted that for the machine intelligence user, a subject triggering the action option may be a cloud server or intelligent terminal run through the machine intelligence software. In this case, different scenario modes of the subtask node may be denoted by different field values. For example, a field value of the first scenario mode may be “000”, and a field value of the second scenario mode of the subtask in the selected state may be “111”.

For a user terminal having an interactive interface, the subtask node corresponding to the first communication action option may be switched to a highlight display mode. Alternatively, a color of the subtask node corresponding to the first communication action option may be switched from white to yellow (a color of other subtask nodes is still white), which is not specifically limited in the examples of the present disclosure.

Illustratively, after acquiring the first collaborative authoring task, the first collaborative authoring community user also acquires the first process task state diagram of the task. The user is generally a member in a first task group included in the first process task state diagram. When the first collaborative authoring community user selects the node in the first process task state diagram, a user interface may present each member associated with the node in the first task group for a human expert user. For example, when the first collaborative authoring community user clicks a task setting information node, an avatar icon of a task releaser is presented; when the first collaborative authoring community user clicks a task template node, an avatar icon of a template releaser is presented; when the first collaborative authoring community user clicks the subtask node, a subtask expert associated with the subtask is presented; and when the first collaborative authoring community user clicks a platform node such as a quality manager, a professional committee member, or an arbitration committee member, a platform expert associated with the platform node is presented. For the machine intelligence user, when accessing these nodes, the machine intelligence user may read information of users associated with each node, for example, the task releaser, the template releaser, the subtask expert, the quality manager, etc., and thus no presentation step is needed. In addition, the first collaborative authoring community user may obtain several communication action options associated with the selected node. The first collaborative authoring community user selects one communication action option, and then triggers the system to initiate the communication action according to settings of the communication action option selected by the first collaborative authoring community user. It should be noted that the machine intelligence user may also select one communication action option, and then trigger the system to initiate a corresponding communication action according to settings of the communication action option selected by the user. For example, the machine intelligence user sets a field value of a scenario mode of one subtask node from “000” to “111”, so as to indicate that the subtask is selected to execute one communication action option. Thus, the system is triggered to initiate a communication action according to settings of the communication action option selected by the user.

In some examples, when the first process node to which a target user site belongs includes a subtask node, step 202 or may be implemented in the following way: in response to a selection operation of selecting a first subtask node in the first process task state diagram by the first collaborative authoring community user, the first subtask node and each subtask node derived from the first subtask node are taken as target nodes, and first process user sites associated with the target nodes are taken as the receiver.

In some other examples, step 202 or may be implemented in the following way: in response to a selection operation at least one first process user site associated with any first process node in the first process task state diagram by the first collaborative authoring community user, the selected at least one first process user site is taken as the receiver.

A process of initiating communication upon selecting an atomic type subtask node is described as an example.

In some examples, for a collaborative authoring task of a patent value evaluation report, when the first collaborative authoring community user (for example, the task releaser) selects a subtask (1) keyword and retrieval strategy node in the first process task state diagram, a user site associated with the node and a subtask (2) comparative document node derived from the node may be taken as the target user sites, and a message may be sent to a member associated with the target user sites in the first task group. Specific steps are as follows: first, the task releaser selects the subtask (1) keyword and retrieval strategy node in the first process task state diagram. Next, the task releaser may obtain several communication action options relevant to the subtask (1) node, for example, a communication action a: initiating communication to the member associated with the subtask (1) node in first task group; a communication action b: initiating communication to members associated with the subtask (1) node and the subtask (2) node in the first task group; a communication action c: initiating communication to members associated with the subtask (1) node, the subtask (2) node, a subtask (3) node, and a subtask (4) node in the first task group; and communication action d: initiating communication to members associated with the subtask (1) node, the subtask (2) node, the subtask (3) node, the subtask (4) node, and a subtask (6) node in the first task group. Then, assuming that the task releaser selects the communication action b, the system establishes group communication. Group communication members include a user site [task releaser, q] belonging to the task setting information node; and user sites belonging to the subtask (1) node, for example, [subtask (1), a1], [subtask (1), a2], [subtask (1), a3], [subtask (1), a4], and [subtask (1), a5]; and user sites belonging to the subtask (2) node, for example, [subtask (2), a3], [subtask (2), b1], [subtask (2), b2], [subtask (2), b3], and [subtask (2), b4]. In this case, the task releaser may submit a communication content to be sent. The communication content may be a text message, a voice, a picture, a video, a file, a voice call, a video call, etc. The system sends the communication content to the above group communication members. The above group communication members may obtain the above communication content. In addition, the above group communication members may reply to the above communication content and submit response communication contents. The system sends the response communication contents to the above group communication members.

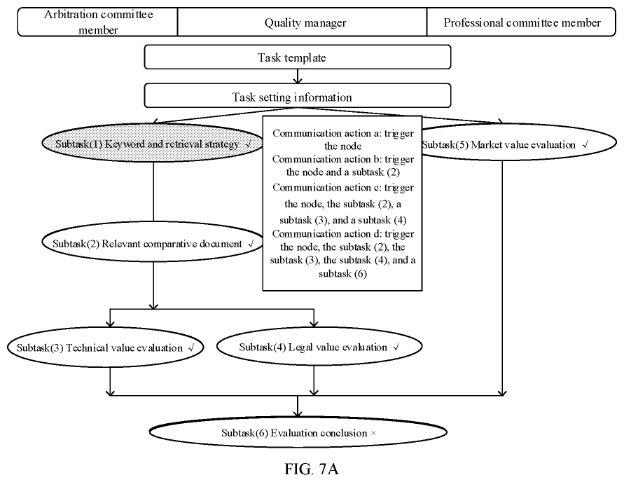

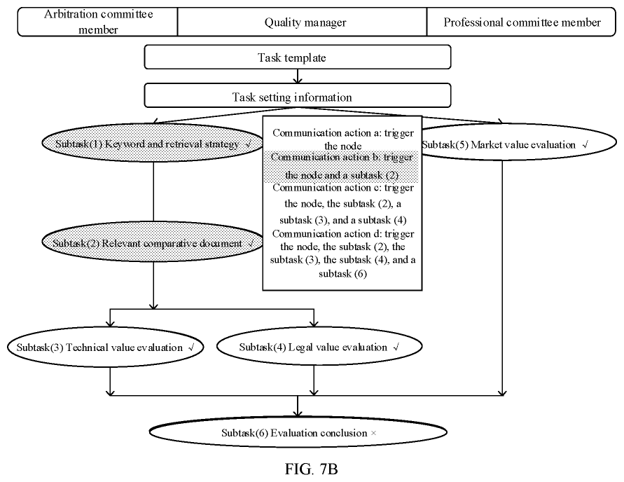

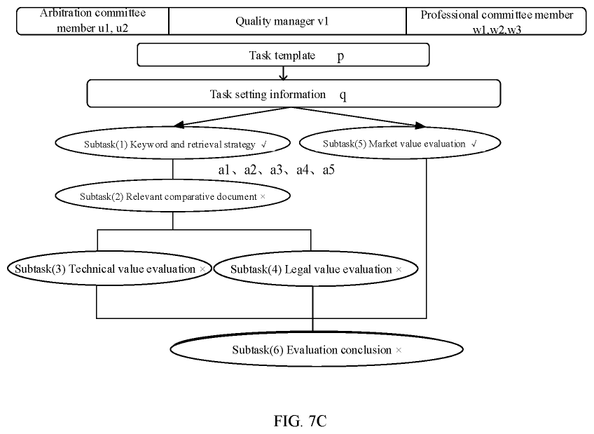

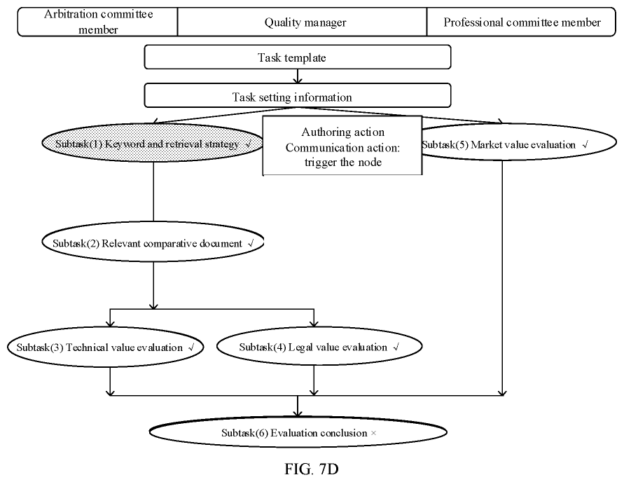

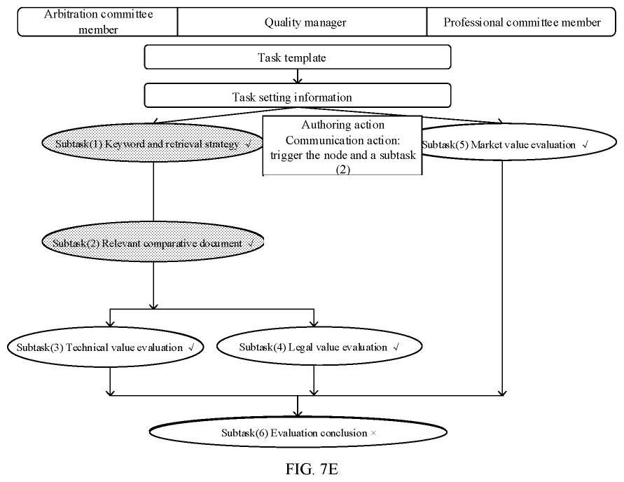

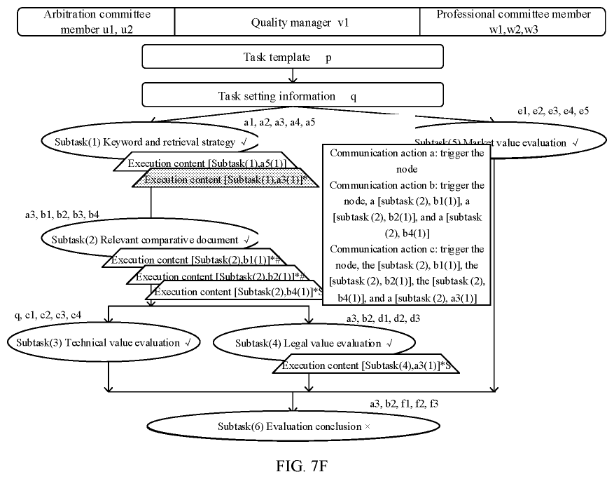

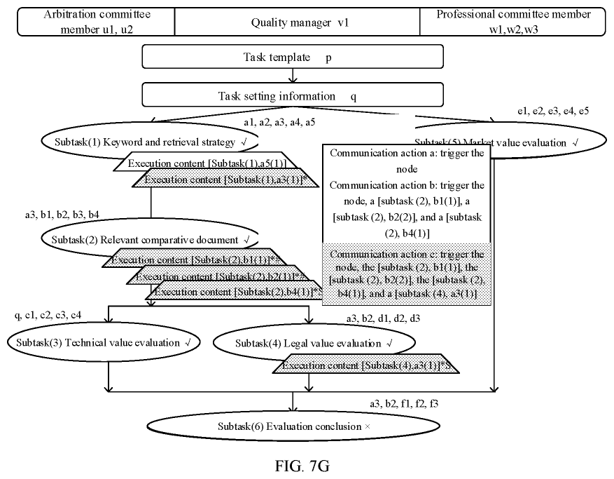

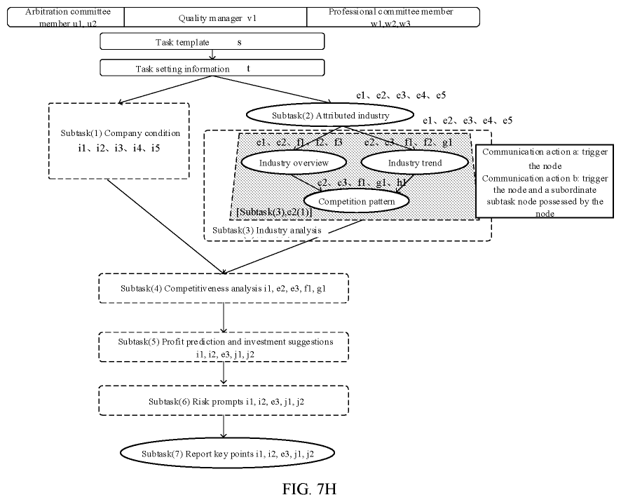

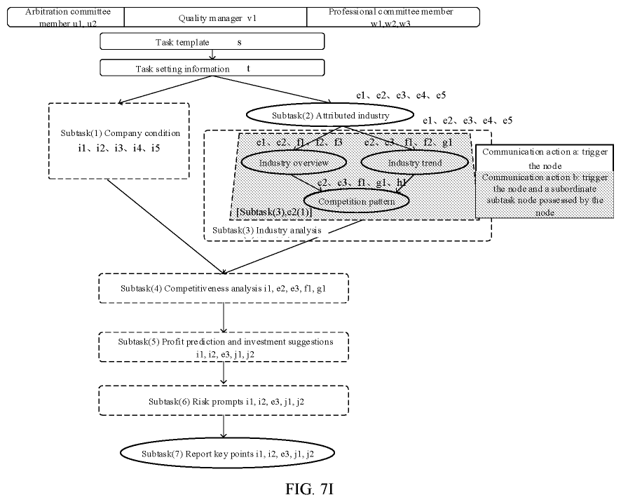

Illustratively, with the collaborative authoring task being the patent evaluation task as an example, with reference to FIG. 7A, a schematic diagram of an application scenario of the method for initiating communication in a collaborative authoring community according to an example of the present disclosure is shown. As shown in FIG. 7A, assuming that the first collaborative authoring community user (for example, the task releaser) selects the subtask (1) node in the first process task state diagram, for example, a click operation by the first collaborative authoring community user on the subtask (1) node is received, the subtask (1) node may be displayed in a highlight manner, and several communication action options, for example, a communication action a: triggering the node; a communication action b: triggering the node and the subtask (2); a communication action c: triggering the node, the subtask (2), the subtask (3), and the subtask (4); and a communication action d: triggering the node, the subtask (2), the subtask (3), the subtask (4), and the subtask (6) may be displayed near the subtask (1) node. As shown in FIG. 7B, assuming that the first collaborative authoring community user selects the communication action b from a plurality of communication action options, field values of scenario modes of the subtask (1) node and the subtask (2) node in the first process task state diagram may be set from “000” to “010”, and/or the subtask (1) node and the subtask (2) node may be switched to a highlight display mode. Thus, it indicates that the subtask (1) node and the subtask (2) node are currently in a selected state.

In some examples, the first collaborative authoring community user or may select the receiver by clicking on the user site. For example, as shown in FIG. 7C, all user sites associated with the subtask (1) keyword and retrieval strategy node include: a [subtask (1), a1], [subtask (1), a2], [subtask (1), a3], [[subtask (1), a4], and [subtask (1), a5]. When a click operation by the first collaborative authoring community user on the user site [subtask (1), a2] in the first process task state diagram is received, a field value of a scenario mode of the user site [subtask (1), a2] may be set from “000” to “010”, and/or the user site may be switched to a highlight display mode. Thus, it indicates that the user site [subtask (1), a2] is currently in a selected state, and in other words, the user site [subtask (1), a2] is taken as the target user site. Moreover, prompt information may also be displayed near the user site [subtask (1), a2], so as to prompt the first collaborative authoring community user that the user site is currently triggered. Next, the system initiates communication to a member associated with the user site [subtask (1), a2] in the first task group.

In some other examples, the first collaborative authoring community user or may select the receiver by clicking on the node. For example, as shown in FIG. 7D, when a click operation by the first collaborative authoring community user on the subtask (1) node in the first process task state diagram, a field value of a scenario mode of the subtask (1) node may be set from “000” to “010”, and/or the subtask (1) node may be switched to a highlight display mode. Thus, it indicates that the subtask (1) node is currently in a selected state. Moreover, prompt information may also be displayed near the subtask (1) node, so as to prompt the user that the node is currently triggered. As shown in FIG. 7E, when a click operation by the first collaborative authoring community user on the subtask (2) node in the first process task state diagram continues to be received subsequently, a field value of a scenario mode the subtask (2) node is set from “000” to “010”, and/or the subtask (2) node is switched to a highlight display mode. Moreover, the prompt displayed near the subtask (1) node may also be updated, so as to prompt the user that the node and the subtask (2) node are currently selected. In other words, the nodes currently in the selected state include the subtask (1) node and the subtask (2) node. Then, the system takes the subtask (1) node and the subtask (2) node as target nodes, acquires user sites (i.e. the target user sites) associated with the target nodes, and initiates communication to members associated with the target user sites in the first task group.

Step 203, communication to the receiver is initiated.

Herein, the receiver may include one or more target user sites, where the one or more first process user sites include the one or more target user sites. In other words, the receiver may be a set of the target user sites selected in the one or more first process user sites by the first collaborative authoring community user.

In some examples, a specific process of initiating communication from the source to the receiver is as follows:
1) The sender and the receiver(s) interact with the collaborative authoring system through user equipment. Specifically, each time one new user site is created in the task state diagram of each collaborative authoring task in the collaborative authoring community, user equipment of a user corresponding to the user site establishes a site sub-inbox corresponding to the user site in its own inbox. The user site includes: user identity information of the user corresponding to the user site, which is traditional addressing information of the user; and node information of a node to which the user site belongs, where the node belongs to one task state diagram, and the one task state diagram belongs to one collaborative authoring task.
2) After the collaborative authoring community user performs registration, a communication server establishes an inbox and an outbox for the user.
3) Each time the user logs in, after the identity verification is passed, the user registers online with the communication server, and informs the communication server that the user can be in contact through a network address (for example, a terminal Internet protocol (IP) and a protocol and port address). Thus, the addressing information of the user is bound to a current network address of the user.
4) An instance of a communication process is described as follows.
4.1) A communication establishment process instance 1: communication of sending a message.
4.1.1) When a source A initiates communication to a receiver B, a user site corresponding to the source A and each user site included in the receiver B are determined first. The user site of the source and the user sites in a receiver set constitute one communication group.
4.1.2) The source A requests a current network address of a user corresponding to each user site included in the receiver B from a communication server T.
4.1.3) The communication server T searches for the current network address {addr_b(n)} of the user corresponding to each user site included in the receiver B according to a request message.
4.1.3.1) If a user b(n) corresponding to one user site included in the receiver B is currently online, the communication server T finds the current network address addr_b(n) of the user b(n) and informs the source A.
4.1.3.2) If a user b(n) corresponding to one user site included in the receiver B is currently offline, the server T cannot find the current network address of the user b(n) and informs the source A.
4.1.4) The source A sends a message to receiver B.
4.1.4.1) For the user site of the corresponding user currently online among the user sites included in the receiver B, the source A sends the message according to the current network address of the user corresponding to the user site, where the message includes user site information of the corresponding user currently online, and further includes user site information corresponding to the source A.

After receiving the message, user equipment of the user corresponding to the user site of the corresponding user currently online puts the message into a site sub-inbox corresponding to the user site, and thus the message sent from the source A is received.
4.1.4.2) For the user site of the corresponding user currently offline among the user sites included in the receiver B, the source A sends the message to its own site sub-outbox, where the message includes user site information of the corresponding user currently offline, and further includes user site information corresponding to the source A. The communication server T forwards the message to an inbox of the user corresponding to the user site according to the user site information included in the message. When the user corresponding to the user site is online again, user equipment of the user corresponding to the user site checks its own inbox on the communication server T, receives the message received when the user is offline, and puts the messages into a site sub-inbox corresponding to the user site. Thus, the message sent from the source A is received.
4.2) A communication establishment process instance 2: communication of a multimedia call.
4.2.1) When a source A initiates communication to a receiver B, a user site corresponding to the source A and user sites included in the receiver B are determined first.
4.2.2) The source A requests a current network address of a user corresponding to the user site included in the receiver B from a communication server T.
4.2.3) The communication server T searches for the current network address addr_b of the user corresponding to the user site included in the receiver B according to a request message.
4.2.3.1) If a user b corresponding to one user site included in the receiver B is currently offline, the server T cannot find the current network address of the user b and informs the source A.
4.2.3.2) If a user b corresponding to one user site included in the receiver B is currently online, the communication server T finds the current network address addr_b of the user b and informs the source A.
4.2.4) The multimedia call between the source A and the receiver B is established.
4.2.4.1) If the user b corresponding to the user site included in the receiver B is currently offline, the call initiated by the source A cannot be connected.
4.2.4.2) If the user b corresponding to the user site included in the receiver B is currently online, the source A may send a message according to the current network address addr_b of the user b, where the message carries a multimedia call invitation instruction, with a network address m_a configured to establish a multimedia channel of the source A and a user site corresponding to the source A attached. After receiving the invitation instruction, the receiver B may choose to accept or reject the invitation instruction, form a response message for the call invitation instruction, and feed the response message back to the source A. If the response of the receiver B for the call invitation instruction is to accept it, the response message is attached with a network address m_b configured to establish the multimedia channel and the user site included in the receiver B. After the source A obtains the multimedia channel address m_b of the receiver B, the multimedia channel between m_a and m_b may be established through a network, so as to implement the multimedia call between the user site corresponding to the source A and the user site included in the receiver B.

In some other examples, before the communication to the receiver is initiated, the following processing may also be executed: a user site corresponding to the first collaborative authoring community user (the source) is sent to the receiver, where the user site corresponding to the first collaborative authoring community user includes: a user identifier of the first collaborative authoring community user and a node identifier of a first process node to which the first collaborative authoring community user belongs in the first process task state diagram. For example, when the first collaborative authoring community user is the task releaser, a user site of the task releaser may be sent to the receiver. The user site of the task releaser includes: an identifier of the task releaser and a node identifier of a task setting information node to which the task releaser belongs in the task state diagram.

It should be noted that in a case where the first collaborative authoring community user is simultaneously associated with a plurality of first process nodes in the first process task state diagram, for example, assuming that the first collaborative authoring community user is the task releaser and a subtask expert of one subtask, the first collaborative authoring community user is simultaneously associated with the task setting information node and one subtask node, the first collaborative authoring community user needs to make a selection. For example, assuming that the first collaborative authoring community user selects the subtask node, the user site includes a node identifier of the subtask node, so as to indicate that a current identity of the first collaborative authoring community user is the subtask expert.

It can be seen that in the examples of the present disclosure, the addressing information of the user site included in the receiver includes: user identity information of the user corresponding to the user site and node identification information of the node to which the user site belongs in the task state diagram. In other words, in the examples of the present disclosure, the addressing information of the user site included in the receiver is user identity information of a member associated with the node in the task state diagram, in the task group. It indicates that the addressing information of the user site included in the receiver includes information in two aspects: the user identity information of the member in the task group; and the node information, associated with the member in the task group, in the task state diagram, where the task state diagram belongs to one collaborative authoring task.

A process of releasing a second collaborative authoring task in a collaborative authoring community continues to be described below, where the collaborative authoring community may include a plurality of users, and each user may include a corresponding user identifier and corresponding user description information.

Illustratively, with reference to FIG. 3B, a schematic flowchart of a method for releasing a collaborative authoring task in a collaborative authoring community according to an example of the present disclosure is shown, and the method is described in conjunction with steps shown in FIG. 3B.

Step 301, a first collaborative authoring task is sent.

Herein, the first collaborative authoring task may include a first process task state diagram, the first process task state diagram may include one or more first process nodes and one or more first process user sites, and the one or more first process user sites belong to the one or more first process nodes.

In some examples, the one or more first process nodes may include a platform node, and the platform node is configured to provide management and/or service for a platform.

Step 302, first authoring information of a first author on the first collaborative authoring task is received.

Herein, the first collaborative authoring task may include one or more subtasks, the first authoring information may include a first execution content, the first execution content belongs to a target subtask in the one or more subtasks, and the target subtask is a subtask selected from the one or more subtasks by the first author.

In some examples, for a machine intelligence user, user equipment for receiving the first collaborative authoring task may be a cloud server or an intelligent terminal run by machine intelligence software. After receiving the first collaborative authoring task sent by the server, user equipment may maintain the first process task state diagram included in the first collaborative authoring task in its random access memory, maintain an authoring state mode of the node in the state diagram, receive a message, store the message in a corresponding record associated with a corresponding node as communication log data, and perform corresponding processing. Also, when the author is an AI user or a machine intelligence user, the first process task state diagram may be directly pushed to a computer/server/computation platform where the AI user or the machine intelligence user is located, where the authoring state is set through a relevant field. For example, authoring state modes of subtasks in an authorable state and subtasks in a non-authorable state may be indicated by different field values. An instance is as follows: the field value of the authoring state mode of the subtask in the authorable state may be “101”; and the field value of the authoring state mode of the subtask in the non-authorable state may be “000”, so as for differentiation.

In some examples, after receiving the first collaborative authoring task sent by the server, the user equipment may further display the first process task state diagram included in the first collaborative authoring task in an interactive interface. In other words, authoring information and an authoring process may be presented graphically through the first process task state diagram, so that the author can intuitively obtain relevant information more conveniently. A step that the subtask in the authorable state is provided for the author, so as for the author to input the authoring information according to the subtask description information includes: first, the first process task state diagram is displayed in the interactive interface; and then, the subtask in the authorable state is set to an authoring state mode in which the subtask can be selected and authored by the author, and displayed in a first authoring state manner. The first authoring state manner herein may be denoted by a color, a shape such as a box or a circle, a special symbol, or a graphic in a certain size. The subtask in the non-authorable state is set to an authoring state mode in which the subtask cannot be selected or authored by the author, and displayed in a second authoring state manner, where the second authoring state manner is different from the first authoring state manner. For example, the subtask in the authorable state and the subtask in the non-authorable state may be denoted in different ways respectively, such as different colors, different fonts, different block shapes, or different symbol labels, and displayed by setting different sizes, etc. The display way is not limited. Through different display ways, the author can clearly know which subtask can be authored and which subtask is to be authored, which is intuitive and convenient.

Step 303, a second collaborative authoring task is generated and released according to the first authoring information and the first collaborative authoring task.

Herein, the second collaborative authoring task may include a second process task state diagram, the second process task state diagram may include one or more second process nodes and one or more second process user sites, and the one or more second process user sites belong to the one or more second process nodes. In addition, the one or more second process nodes may include the one or more first process nodes and a first execution content node corresponding to the first execution content; the one or more second process user sites include the one or more first process user sites and a user site corresponding to the first author; and the user site corresponding to the first author belongs to the first execution content node.

In some examples, each first process node includes a node identifier and each second process node includes a node identifier; each first process user site includes: a user identifier of a user corresponding to the first process user site and a node identifier of a first process node to which the first process user site belongs; and each second process user site includes: a user identifier of a user corresponding to the second process user site and a node identifier of a second process node to which the second process user site belongs.

In some examples, the second process task state diagram may be obtained by adding the first authoring information authored by the first author on the target subtask to the first process task state diagram. The second process task state diagram may include a second task group and a plurality of second process nodes, and the second task group includes a plurality of users associated with the plurality of second process nodes respectively. The plurality of second process nodes may include: a task setting information node; subtask nodes corresponding to subtasks that do not depend on other subtasks and can be directly authored in the plurality of subtasks; an execution content node; and subtask nodes corresponding to subtasks that only depend on an execution content in the plurality of subtasks.

Illustratively, for the foregoing first collaborative authoring task received, a subtask expert may select the subtask to input authoring information and generate an execution content corresponding to the subtask, including: setting author identity information of a subtask execution content, generating an execution content identifier, generating authoring content information, and generating content relation information. After released, the subtask execution content becomes a subtask execution content accepted by the system and is included in a collaborative authoring subtask execution content library of digital work.

For example, when a first execution content [subtask (1), a3(1)] is released, the task state diagram of the collaborative authoring task possesses an execution content node [subtask (1), a3(1)] for the first time, and thus the second process task state diagram is generated. The second process task state diagram includes a second task group, and group members include: a task releaser associated with the task setting information node and/or a template releaser associated with a task template node, subtask experts associated with each subtask node, and an execution content author associated with the execution content node.

The execution content author associated with the execution content node is one of the subtask experts associated with the subtask node to which the execution content belongs. In other words, if no new subtask expert is provided for the subtask node after the task is released, for a non-structured task group, the group members in the second task group included in the second process task state diagram are not different from those in the first process task state diagram, and no new user is added. However, for a structured task group, the group members in the second task group included in the second process task state diagram are different from those in the first process task state diagram in that a new execution content author associated with the execution content node is added.

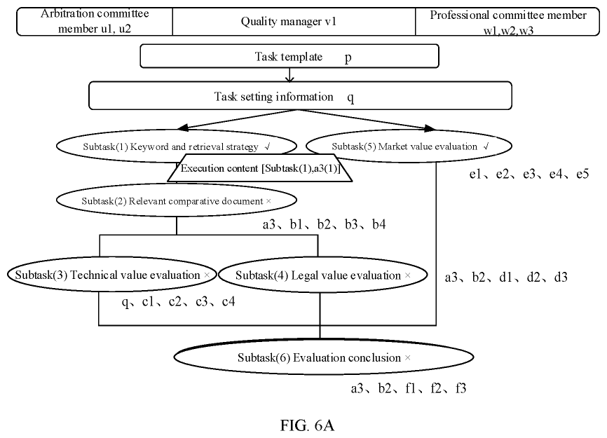

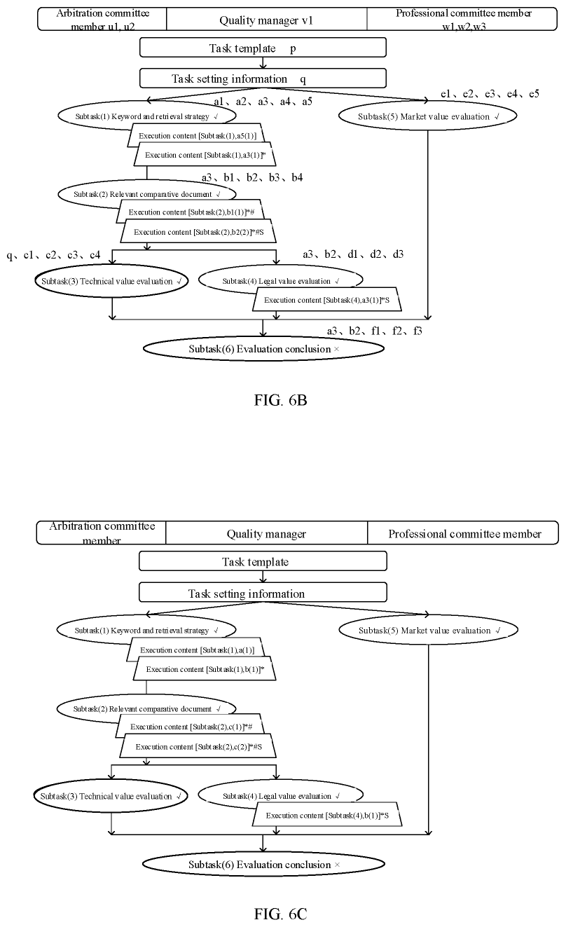

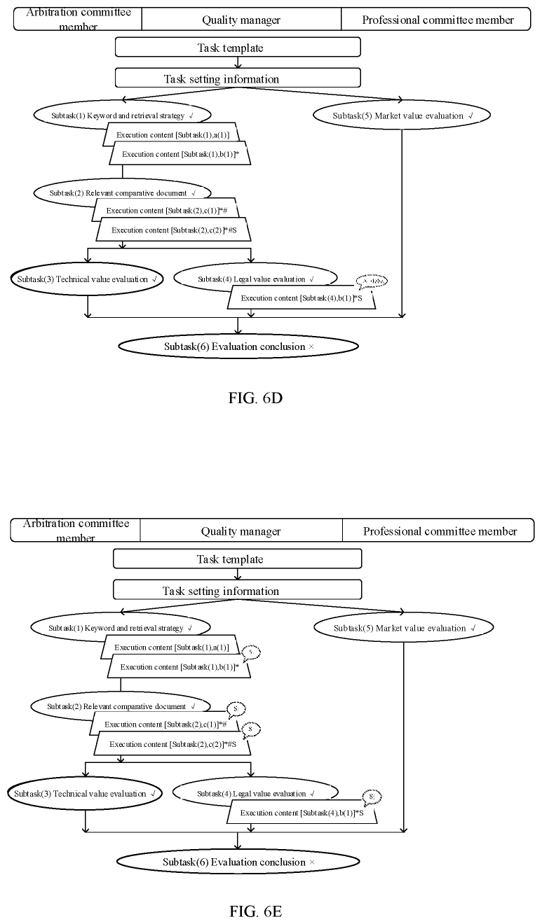

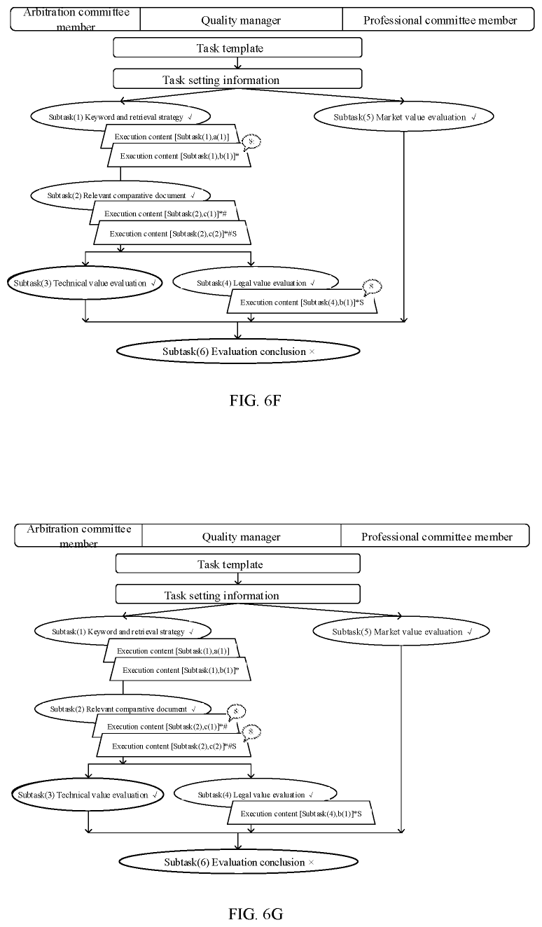

Illustratively, with the collaborative authoring task being a patent evaluation task as an example, with reference to FIG. 6A, a second process task state diagram according to an example of the present disclosure is shown. As shown in FIG. 6A, a subtask expert a3 who authors the execution content [subtask (1), a3(1)] exists in subtask experts associated with a subtask (1). Thus, the new execution content author a3 associated with the execution content node [subtask (1), a3(1)] is added to the second task group included in the second process task state diagram.

In some examples, after the second collaborative authoring task is generated, the second process task state diagram included in the second collaborative authoring task may also be pushed to users in the second task group.

Illustratively, the second task group may include only the following users: the task releaser associated with the task setting information node; a subtask expert associated with a subtask node corresponding to a subtask that does not depend on other subtasks and can be directly authored in the plurality of subtasks; and a subtask expert associated with a subtask node corresponding to a subtask that only depends on a generated execution content in the plurality of subtasks. For example, with the collaborative authoring task being the patent evaluation as an example, the patent evaluation may be decomposed into six subtasks of a keyword and retrieval strategy, a relevant comparative document, technical value evaluation, legal value evaluation, market value evaluation, and an evaluation conclusion. Assuming that the keyword and retrieval strategy and the market value evaluation are subtasks that do not depend on other subtasks and can be directly authored in the six subtasks, and moreover, the keyword and retrieval strategy has possessed an execution content, while the relevant comparative document is a subtask that only depends on the execution content of the keyword and retrieval strategy in the six subtasks, the second task group may include only the following users: the task releaser; a subtask expert associated with a keyword and retrieval strategy node; a subtask expert associated with a market value evaluation node; and a subtask expert associated with a relevant comparative document node.

It should be noted that in some cases, the above subtask that only depends on the execution content generated or may not exist, because some subtasks need to depend on a previous batch of a plurality of subtasks, but it is not sufficient to make a next batch of subtasks authorable if only one subtask possesses the execution content.

In addition, it should also be noted that the action of pushing the second process task state diagram to the users in the second task group is to prepare for a communication process between the users in the second task group, and does not belong to the communication process itself. Thus, there is no receiver or source in this case. The concept of the receiver or source indicates an identity that appears only in a process of establishing communication between the users in the second task group. In the process of establishing the communication, the user who sends a message in the second task group serves as the source, and the user who receives the message serves as the receiver. In a conversation progress of the communication process, when receiving a message, the user in the second task group serves as the receiver, and when replying with a new message, the user becomes the source of the new message.

In some other examples, the plurality of second process nodes may further include at least one of the following nodes: subtask nodes corresponding to other subtasks; a task template node; and a platform node. Other subtask nodes are subtask nodes corresponding to subtasks, other than the subtask that does not depend on other subtasks and can be directly authored, and the subtask that only depends on the execution content, in the plurality of subtasks. In other words, the second task group may further include at least one of the following users: the template releaser associated with the task template node; platform experts associated with all the platform node, for example, a quality manager, a professional committee member, and an arbitration committee member; and subtask experts associated with subtask nodes corresponding to remaining subtasks in the plurality of subtasks.

In some examples, along with an update of an authoring progress of the collaborative authoring task, the second process task state diagram may also be updated synchronously.

Illustratively, with the collaborative authoring task being the patent evaluation task as an example, with reference to FIG. 6B, a third process task state diagram according to an example of the present disclosure is shown. As shown in FIG. 6B, along with the development of a collaborative authoring activity, an increasing number of execution content nodes exist in the second process task state diagram. Each time an execution content node is added, the second process task state diagram is updated, and an execution content author associated with the execution content node is added simultaneously. In other words, along with the development of the collaborative authoring activity, the second process task state diagram is updated to a third process task state diagram. In FIG. 6B, the execution content nodes marked with identifiers and “S” indicate that they have a dependency-derivation content relation with the execution content nodes marked with identical identifiers. The execution content nodes marked with an identifier “#” indicate that they have an inheritance-revision content relation with the execution content nodes marked with an identical identifier. The subtask nodes marked with an identifier “V” indicate that they are in an authorable state. The subtask nodes marked with an identifier “X” indicate that they are in a non-authorable state.

In addition, the second task group may also be updated while the second process task state diagram is updated. In an update process, author identity information of a released execution content is included in a corresponding execution content node, so that the second task group is updated. Group members in an updated second task group include: the task releaser associated with the task setting information node in the second process task state diagram, and/or the template releaser associated with the task template node; a subtask expert associated with each subtask node; and an execution content author associated with each execution content node.

Illustratively, in FIG. 6B, the execution content authors associated with each execution content node include: an execution content author a3 associated with an execution content node [subtask (1), a3(1)]; an execution content author a5 associated with an execution content node [subtask (1), a5(1)]; an execution content author b1 associated with an execution content node [subtask (2), b1(1)]; an execution content author b2 associated with an execution content node [subtask (2), b2(2)]; and an execution content author a3 associated with an execution content node [subtask (4), a3(1)].

In some other examples, after the updated second process task state diagram is acquired, the following processing may also be executed: the updated second process task state diagram (i.e. the third process task state diagram) is sent to the users in the second task group, where the updated second process task state diagram includes the updated second task group. In other words, each time the second process task state diagram is updated, the server pushes the updated second process task state diagram to the members in the second task group.

In other words, in the examples of the present disclosure, the second process task state diagram includes only one execution content node, and the task state diagram possessing two or more execution content nodes is referred to as the third process task state diagram or a fourth process task state diagram.

In addition, it should also be noted that even if the new author of the execution content node and the user associated with one previous node are a same user (i.e. two receivers or sources point to a same user), the server still needs to push the updated second task group because the second task group is structurally changed. In addition, it should also be noted that pushing the second process task state diagram is not a group communication action, and thus can be merged instead of being performed separately. For example, if the execution content author a3 associated with the execution content node [subtask (1), a3(1)] and the execution content author a3 associated with the execution content node [subtask (4), a3(1)] are a same user, only one second process task state diagram needs to be pushed to the user a3.

In some other examples, the above first execution content may include one or more subordinate subtasks; the one or more second process nodes may further include one or more subordinate subtask nodes corresponding to the one or more subordinate subtasks; and the second process task state diagram may further include an association relation between the one or more subordinate subtask nodes and the one or more second process user sites.

Illustratively, the association relation between the one or more subordinate subtask nodes and the one or more second process user sites may be determined in the following way: for at least one subordinate subtask node of the one or more subordinate subtask nodes, a second process user site associated with the at least one subordinate subtask node is determined in at least one of the following ways: the second process user site associated with the at least one subordinate subtask node is determined by direct assigning; and the second process user site associated with the at least one subordinate subtask node is determined by intelligent matching.

Illustratively, the subordinate subtask may include subtask description information. The step that the second process user site associated with the at least one subordinate subtask node is determined by intelligent matching may be implemented in the following way: processing is performed on each subordinate subtask node as follows: the subtask description information of a subordinate subtask corresponding to the subordinate subtask node is matched with the user description information of each of the plurality of users, so as to obtain at least one user having a highest-ranking matching degree; and the second process user site associated with the subordinate subtask node is determined according to the at least one user having a highest-ranking matching degree.

It should be noted that a process of associating the second process user site with the subordinate subtask node is similar to a process of associating the first user site with the subtask node, may be implemented with reference to the above method for associating the first user site with the subtask node, and thus will not be repeated herein in the examples of the present disclosure.

A process of initiating communication in a collaborative authoring community based on a second process task state diagram included in a second collaborative authoring task is described below, where the collaborative authoring community may include a plurality of users.

Illustratively, with reference to FIG. 4B, a schematic flowchart of a method for initiating communication in a collaborative authoring community according to an example of the present disclosure is shown, and the method is described in conjunction with steps shown in FIG. 4B.

Step 401, a second collaborative authoring task is acquired.

Herein, the second collaborative authoring task may include a second process task state diagram, the second process task state diagram may include one or more second process nodes and one or more second process user sites, the one or more second process user sites belong to the one or more second process nodes, and the plurality of users include users corresponding to the one or more second process user sites.

In some examples, each user may include a corresponding user identifier; the second process node may include a node identifier; and each second process user site may include: a user identifier of a user corresponding to the second process user site and a node identifier of a second process node to which the second process user site belongs.

In some other examples, the above one or more second process nodes may include a platform node, and the platform node is configured to provide management and/or a service for a platform.

Step 402, a receiver selected in the second process task state diagram by a second collaborative authoring community user is acquired.

In some examples, step 402 may be implemented in the following way: in response to a selection operation of selecting at least one second process node in the second process task state diagram by the second collaborative authoring community user, at least one second process user site associated with the selected at least one second process node is taken as the receiver.

Illustratively, the step that in response to a selection operation of selecting at least one second process node in the second process task state diagram by the second collaborative authoring community user, at least one second process user site associated with the selected at least one second process node is taken as the receiver may be implemented in the following way: in response to determining that the at least one second process node is selected in the second process task state diagram by the second collaborative authoring community user, all second process user sites associated with the selected at least one second process node are acquired; and in response to determining that at least one second process user site is selected from all the associated second process user sites by the second collaborative authoring community user, the selected at least one second process user site is taken as the receiver.

Illustratively, when the second process node to which a target user site belongs includes an execution content node, the step that in response to a selection operation of selecting at least one second process node in the second process task state diagram by the second collaborative authoring community user, at least one second process user site associated with the selected at least one second process node is taken as the receiver or may be implemented in the following way: in response to determining that a first execution content node is selected in the second process task state diagram by the second collaborative authoring community user, at least one communication action option associated with the first execution content node is acquired, where each communication action option corresponds to at least one execution content node; and in response to determining that a second communication action option is selected from the at least one communication action option by the second collaborative authoring community user, at least one second process user site associated with an execution content node corresponding to the second communication action option is taken as the receiver.

It should be noted that the above first execution content node may include: an execution content node of an atomic type subtask and an execution content node of a framework type subtask. A communication action option relevant to the execution content node of the atomic type subtask includes at least one of the following: initiating communication to an author associated with the execution content node of the atomic type subtask; initiating communication to an author associated with at least one execution content node derived from the execution content node of the atomic type subtask; and initiating communication to the author associated with the execution content node of the atomic type subtask and the author associated with at least one execution content node derived from the execution content node of the atomic type subtask. A communication action option associated with the execution content node of the framework type subtask includes at least one of the following: initiating communication to an author associated with the execution content node of the framework type subtask; initiating communication to the author associated with the execution content node of the framework type subtask and an author associated with an execution content node of a subordinate subtask included in the framework type subtask; and initiating communication to a subtask expert associated with the subordinate subtask included in the framework type subtask.

In some other examples, following the above instance, in response to determining that the second communication action option is selected from the at least one communication action option by the second collaborative authoring community user, the following processing may also be executed: the execution content node corresponding to the second communication action option is switched from a third scenario mode to a fourth scenario mode, so as to indicate that the execution content node corresponding to the second communication action option is currently in a selected state, where the third scenario mode is different from the fourth scenario mode. For example, a field value of the scenario mode of the execution content node corresponding to the second communication action option may be set from “010” to “110”, and/or the execution content node is switched to a highlight display mode; and alternatively, a color of the execution content node corresponding to the second communication action option may be switched from white to yellow (a color of other subtask nodes is still white), which is not specifically limited in the examples of the present disclosure.

In some examples, when the second process node to which a target user site belongs includes a subtask node, step 402 or may be implemented in the following way: in response to a selection operation of selecting a first subtask node in the second process task state diagram by the second collaborative authoring community user, the first subtask node and each execution content node possessed by the first subtask node are taken as target nodes, and second process user sites associated with the target nodes are taken as the receiver.

Illustratively, with the second collaborative authoring task being a collaborative patent value evaluation report authoring task as an example, the second collaborative authoring community user (for example, a quality manager v1 associated with a quality manager node, with a corresponding user site [quality manager node, v1]) selects a subtask node subtask (2) in the second process task state diagram, and initiates communication to receiver group members associated with the node and each execution content node possessed by the node. Specific steps are as follows: the quality manager v1 selects the subtask node subtask (2), so as to obtain several communication action options relevant to the subtask (2) node; the quality manager v1 selects one communication action, and the system initiates communication, where the target user sites include: {[subtask (2), b1(1)], b1}, {[subtask (2), b2(2)], b2}, and {[subtask (2), b4(1)], b4}; and other user sites {subtask (2), a3} and {subtask (2), b3} associated with the subtask node subtask (2). The quality manager v1 submits a communication to be sent. The communication content may be a text message, a voice, a picture, a video, a file, a voice call, a video call, etc. The system sends the communication content to the above group communication members. A user site of a source of a communication content is {quality manager, v1}. In this case, the above group communication members may obtain the above communication content.

In some other examples, when the second process node to which a target user site belongs includes an execution content node, step 402 or may be implemented in the following way: in response to a selection operation of selecting a first execution content node in the second process task state diagram by the second collaborative authoring community user, the first execution content node and each execution content node derived from the first execution content node are taken as target nodes, and second process user sites associated with the target nodes are taken as the receiver.

In some examples, when the second process node to which a target user site belongs includes a framework type subtask node, step 402 or may be implemented in the following way: in response to a selection operation of selecting a first framework type subtask node in the second process task state diagram by the second collaborative authoring community user, the first framework type subtask node, each execution content node possessed by the first framework type subtask node, and all subordinate subtask nodes possessed by each execution content node are taken as target nodes, and second process user sites associated with the target nodes are taken as the receiver.

In some other examples, when the second process node to which a target user site belongs includes a subtask node, step 402 or may be implemented in the following way: in response to a selection operation of selecting a first subtask node in the second process task state diagram by the second collaborative authoring community user, the first subtask node and each subtask node derived from the first subtask node are taken as target nodes, and second process user sites associated with the target nodes are taken as the receiver.

Illustratively, when the second collaborative authoring community user selects one second process node in the second process task state diagram, for a human expert user, a user interface may present each member associated with the node in a second task group. For example, in a case of clicking on a task setting information node, an avatar icon of a task releaser is presented; in a case of clicking on a task template node, an avatar icon of a template releaser is presented; in a case of clicking on the subtask node, a subtask expert associated with the subtask is presented; and in a case of clicking on a platform node such as a quality manager, a professional committee member, or an arbitration committee member, a platform expert associated with the platform node is presented. For a machine intelligence user, when accessing these nodes, the machine intelligence user may read the users including the task releaser, the template releaser, the subtask expert, and the quality manager associated with all the nodes, and thus no presentation step is needed. Then, the second collaborative authoring community user may obtain several communication action options associated with the selected second process node. The second collaborative authoring community user selects one communication action option, and then triggers the system to initiate the communication action according to settings of the communication action option selected by the second collaborative authoring community user. It should be noted that the machine intelligence user may also select one second process node in the second process task state diagram, so as to read information of each member associated with the node in the second task group. Then, the machine intelligence user may obtain several communication action options associated with the selected second process node. The machine intelligence user selects one communication action option, and then triggers the system to initiate the communication action according to settings of the communication action option selected by the user.

Initiating communication upon selecting an execution content node of an atomic type subtask node is described as an example below.

In some examples, for the collaborative patent value evaluation report authoring task, the second collaborative authoring community user (for example, a quality manager v1 associated with a quality manager node, with a corresponding user site [quality manager node, v1]) selects an execution content node [subtask (1), a3(1)] in the second process task state diagram, and initiates communication to members associated with the node and an execution content node derived from the node and belonging to the subtask (2) in the second task group. A specific process is as follows: first, in a case of assuming that the quality manager v1 selects an execution content node [subtask (1), a3(1)] in the second process task state diagram, the quality manager v1 may obtain several communication action options relevant to a node [subtask (1), a3(1)], for example, a communication action a: initiating communication to a member a3 associated with the node [subtask (1), a3(1)] in the second task group; a communication action b: initiating communication to members associated with the node [subtask (1), a3(1)] and execution content nodes [subtask (2), b1(1)], [subtask (2), b2(2)], and [subtask (2), b4(1)] derived from the node in the second task group; and a communication action c: initiating communication to members associated with the node [subtask (1), a3(1)] and execution content nodes [subtask (2), b1(1)], [subtask (2), b2(2)], [subtask (2), b4(1)], and [subtask (4), a3(1)] derived from the node in the second task group. Assuming that the quality manager v1 selects the communication action c, the system establishes group communication according to the communication action c selected by the quality manager v1. A receiver set includes the following four user sites: [subtask (1), a3(1)], a3], [subtask (2), b1(1)], b1], [[subtask (2), b2(2)], b2], [[subtask (2), b4(1)], b4], and [[subtask (4), a3(1)], a3]. Then, the quality manager v1 may submit a communication content to be sent. The communication content may be a text message, a voice, a picture, a video, a file, a voice call, a video call, etc. The system sends the communication content to the above group communication members. The above group communication members may obtain the above communication content. In addition, the above group communication members reply to the above communication content, and submit response communication contents. The system sends the response communication contents to the above group communication members including the quality manager v1.

Illustratively, with the second collaborative authoring task being a patent evaluation task as an example, with reference to FIG. 7F, a schematic diagram of an application scenario of the method for initiating communication in a collaborative authoring community according to an example of the present disclosure is shown. As shown in FIG. 7F, assuming that the second collaborative authoring community user (for example, the quality administrator v1, with the corresponding user site [quality manager node, v1]) selects the execution content node [subtask (1), a3(1)] in the second process task state diagram, a field value of a scenario mode of the node [subtask (1), a3(1)] may be set from “000” to “010”, and/or the execution content node may be switched to a highlight mode. Moreover, for a user terminal having an interactive interface, several relevant communication action options may also be displayed near the node [subtask (1), a3(1)]. Alternatively, for a machine intelligence user, data fields corresponding to several communication action options may be set in a running storage space, for example, a communication action a: triggering the node; a communication action b: triggering the node, [subtask (2), b1(1)], [subtask (2), b2(2)], [subtask (2), b4(1)], and [subtask (4), a3(1)]; and a communication action c: triggering the mode, [subtask (2), b1(1)], [subtask (2), b2(2)], [subtask (2), b4(1)], and [subtask (4), a3(1)]. As shown in FIG. 7G, assuming that the user selects the communication action c from the above three communication action options, field values of scenario modes of the nodes [subtask (2), b1(1)], [subtask (2), b2(2)], [subtask (2), b4(1)], and [subtask (4), a3(1)] may be set from “000” to “010”, and/or the nodes may be switched to a highlight display mode, so as to indicate that the nodes [subtask (1), a3(1)], [subtask (2), b1(1)], [subtask (2), b2(2)], [subtask (2), b4(1)], and [subtask (4), a3(1)] are currently in a selected state.

Initiating communication upon selecting an execution content node of a framework type subtask continues to be described as an example below.

In some examples, for a collaborative enterprise research report authoring task, the second collaborative authoring community user (for example, a task releaser t associated with the task setting information node, with a corresponding user site [task setting information node, t]) selects an execution content node [subtask (3), e2(1)] of the framework type subtask in the second process task state diagram, and initiates communication to a group member e2 associated with the node and members associated with subordinate subtask nodes belonging to the node in the second task group. A specific process is as follows: the task releaser t selects the execution content node [subtask (3), e2(1)] in the second process task state diagram. In this case, the task releaser may obtain several communication action options relevant to the node [subtask (3), e2(1)], for example, a communication action a: initiating communication to a member e2 associated with the node [subtask (3), e2(1)] in the second task group; a communication action b: initiating communication to a member e2 associated with the node [subtask (3), e2(1)] in the second task group and members associated with subordinate subtasks possessed by the node in the second task group; and a communication action c: initiating communication to members associated with the subordinate subtasks possessed by the node [subtask (3), e2(1)] in the second task group. Assuming that the task releaser t selects the above communication action b, the system may establish group communication according to the communication action b selected by the task releaser t. The group communication members include: the task releaser t, with the corresponding user site [task setting information node, t]; a member e2 associated with the node [subtask (3), e2(1)] and having a corresponding user site [task setting information node, t] in the second task group; and members associated with the subordinate subtasks possessed by the node (i.e. subtask experts associated with the subordinate subtasks included in the framework type subtask) and having a corresponding user site [[subtask (3), e2(1)], e2] in the second task group. Then, the task releaser t may submit a communication content to be sent. The communication content may be a text message, a voice, a picture, a video, a file, a voice call, a video call, etc. The system may send the communication content to the above group communication members. The above group communication members may obtain the above communication content. In addition, the above group communication members reply to the above communication content, and submit response communication contents. The system sends the response communication contents to the above group communication members including the task releaser t.

Illustratively, with the collaborative authoring task being an enterprise research report as an example, with reference to FIG. 7H, a schematic diagram of an application scenario of the method for initiating communication in a collaborative authoring community according to an example of the present disclosure is shown. As shown in FIG. 7H, when a selection operation of selecting the execution content node [subtask (3), e2(1)] of the framework type subtask in the second process task state diagram by the second collaborative authoring community user (for example, the task releaser t) is received, the node [subtask (3), e2(1)] may be switched to a highlight display mode. Moreover, several communication action options may also be displayed near the node [subtask (3), e2(1)], for example, a communication action a: triggering the node; and a communication action b: triggering the node and a subordinate subtask node possessed by the node. As shown in FIG. 7I, when the task releaser t selects the communication action b, the subordinate subtask nodes possessed by the node [subtask (3), e2(1)] may also be switched to a highlight display mode, so as to indicate that the subordinate subtask nodes possessed by the node [subtask (3), e2(1)] are also currently in a selected state.

In some examples, step 402 or may be implemented in the following way: in response to a selection operation of selecting at least one second process user site associated with any second process node in the second process task state diagram by the second collaborative authoring community user, the selected at least one second process user site is taken as the receiver.

Step 403, communication to the receiver is initiated.

Herein, the receiver include: one or more target user sites, where the one or more second process user sites include the one or more target user sites. In other words, the receiver is a set of the one or more target user sites selected from the one or more second process user sites by the second collaborative authoring community user.

In some examples, with initiating message communication as an example, a relevant instance of a specific process of “initiating point-to-multipoint communication from the source to the receiver” is described as follows:
1) With a user site [task releaser, q] as a source, a user q selects to initiate message communication to user sites respectively associated with the node [subtask (1), b(1)] and an execution content node derived from the node.
2) According to the second process task state diagram, a receiver set of the present communication is extracted. In the instance, the receiver set includes four user sites: [[subtask (1), b(1)], b], [[subtask (2), c (1)], c], [[subtask (2), c (2)], c], and [[subtask (4), b (1)], b]. A user site of the source and the user sites in the receiver set constitute one communication group.
3) The source sends a message to its outbox on the communication server T, with information of the foregoing four user sites attached.
4) The communication server T searches for current network addresses of users b and c according to the information of the four user sites.
4.1) If the users b and c are currently online, the communication server T sends the message to the corresponding users according to the current network addresses addr_b and addr_c found of the users b and c. The message includes the information of the foregoing four user sites.
4.2) If the receiver is currently offline, the communication server T cannot find current network addresses of users corresponding to the user sites included in the receiver and informs the source.
5) The source sends a message to the receiver.
5.1) If the users b and c are currently online, the user q sends a message to the current network addresses addr_b and addr_c of the users b and c, where the message includes the information of the four user sites in the receiver set, and further includes information of a user site [task releaser, q] corresponding to the source. After receiving the message, user equipment of the users b and c puts the message into site sub-inboxes corresponding to the user sites, including site sub-inboxes of two user sites [[subtask (1), b(1)], b] and [[subtask (4), b(1)], b] of the user b, and site sub-inboxes of two user sites [subtask (2), c (1)], c] and [subtask (2), c (2)], c] of the user c, so as to receive the message sent from the user site [task releaser, q] of the source.

5.2) If the users b and c are currently offline, the communication server T sends the message to inboxes of the users b and c on the communication server T. The message includes the information of the four user sites in the receiver set, and further includes information of a user site [task releaser, q] corresponding to the source. When the users b and c are online again, the user equipment of the users b and c checks their own inboxes on the communication server T, receives the message received when they are offline, and puts the messages in site sub-inboxes corresponding to the user sites, so as to receive the message sent from the source A.

It should be noted that for the user who can serve as the source and the receiver, a communication record and a communication content initiated from the source to the receiver are associated with the node associated with the receiver, and become communication log data belonging to the node. A structured relation between the communication log data is consistent with a structured relation between the nodes to which the communication log data belong.

With the above “initiating point-to-multipoint message communication from the source to the receiver” as an example, the source selects to initiate message communication to authors respectively associated with the node [subtask (1), b(1)] and an execution content node derived from the node. A node set for the present communication includes nodes [subtask (1), b(1)], [subtask (2), c (1)], [subtask (2), c (2)], and [subtask (4), b(1)], and communication log data of the message belong to these four nodes. A third process task state diagram belonging to the source is shown in FIG. 6E, a third process task state diagram belonging to the receiver b is shown in FIG. 6F, and a third process task state diagram belonging to the receiver c is shown in FIG. 6G.

In some examples, the source may also select a second process node to which it belongs in the second process task state diagram when initiating the communication to the receiver. Then, a communication record and a communication content of the present communication are associated with the node, and become communication log data belonging to the node. A structured relation between the communication log data is consistent with a structured relation between the nodes to which the communication log data belong.

With the message communication as an example, a specific process of forming the communication log data belonging to the node after source communication is described in combination with FIG. 6C as follows:
1) A source A (i.e. a third collaborative authoring community user) needs to select a receiver from a third process task state diagram when initiating communication. In the instance of the present disclosure, it is assumed that the source A selects a user site [subtask (4), b(1)], b] associated with an execution content node [subtask (4), b(1)] in the third process task state diagram as the receiver. A user site of the source and the user sites in the receiver set constitute one communication group.
2) When initiating communication to the receiver, the source A requests a current network address of a user b from the communication server T first, and then sends a message to the current network address of the user b, where the message includes information of the user site [subtask (4), b(1)], b].
3) After receiving the message sent from the source A, the user b put the message into a site sub-inbox corresponding to the user site [[subtask (4), b(1)], b] according to the information of the user site [subtask (4), b(1)], b] included in the message, so as to receive the message sent from the source A.
4) For user equipment having a man-machine interface of the user b, a third process task state diagram belonging to the user b is shown in FIG. 6D. A machine intelligence user maintains the third process task state diagram in its random access memory. The user site corresponding to the receiver in the third process task state diagram receives the message, stores the message in the site sub-inbox of the corresponding user site as communication log data, and performs corresponding processing.
5) A member b in the foregoing third task group and a member A in the foregoing third task group have each a structured communication log database with the third process task state diagram as a structural framework, and present the communication log data on the man-machine interface with the third process task state diagram as the structural framework. A structured relation exists between the communication log data in the structured communication log database and is consistent with a structured relation between receiver nodes to which the communication log data belong. The machine intelligence user needs to maintain the third process task state diagram in its random access memory. The corresponding user site associated in the source or receiver in the third process task state diagram receives the message, and the site sub-inbox of the corresponding user site constitutes the communication log data.

For the user who can serve as the source and the receiver, such as the task releaser and each execution content author, the attribution rules of communication data are as follows:

If such a user selects the receiver from the third process task state diagram before initiating communication, an identity of the user in the present communication is the source. Correspondingly, the communication record and the communication content of the communication are associated with the receiver selected before, and become communication log data belonging to the receiver selected by the user.

If such a user responds to communication initiated by another user instead of selecting the receiver before initiating communication, an identity of such a user in the present communication is the receiver. Correspondingly, the communication record and the communication content of the communication are associated with a receiver selected by another user before the present communication is initiated, and become communication log data belonging to the receiver selected by another user.

In some other examples, before the communication to the receiver is initiated, the following processing may also be executed: a user site corresponding to the second collaborative authoring community user (i.e. the source) to the receiver, where the user site corresponding to the second collaborative authoring community user includes: a user identifier of the second collaborative authoring community user and a node identifier of a second process node to which the second collaborative authoring community user belongs in the second process task state diagram. For example, when the second collaborative authoring community user is the task releaser, a user site of the task releaser may be sent to the receiver. The user site of the task releaser includes: an identifier of the task releaser and a node identifier of a task setting information node to which the task releaser belongs in the second process task state diagram.

It should be noted that in a case where the second collaborative authoring community user is simultaneously associated with a plurality of second process nodes in the second process task state diagram, for example, assuming that the second collaborative authoring community user is the task releaser and a subtask expert of one subtask, the second collaborative authoring community user is simultaneously associated with the task setting information node and one subtask node, and the second collaborative authoring community user needs to make a selection. For example, assuming that the second collaborative authoring community user selects the subtask node, the user site includes a node identifier of the subtask node, so as to indicate that a current identity of the second collaborative authoring community user is the subtask expert.

A process of releasing a fourth collaborative authoring task in a collaborative authoring community continues to be described below, where the collaborative authoring community may include a plurality of users, and each user may include a corresponding user identifier and corresponding user description information.

Illustratively, with reference to FIG. 3C, a schematic flowchart of a method for releasing a collaborative authoring task in a collaborative authoring community according to an example of the present disclosure is shown, and the method is shown in conjunction with steps shown in FIG. 3C.

Step 501, a third collaborative authoring task is sent.

Herein, the third collaborative authoring task may include a third process task state diagram, the third process task state diagram may include one or more third process nodes and one or more third process user sites, the one or more third process user sites belong to the one or more third process nodes, and the plurality of users include users corresponding to the one or more third process user sites.

In some examples, the above one or more second process nodes may include a platform node, and the platform node is configured to provide management and/or a service for a platform.

Step 502, second authoring information of a second author on the third collaborative authoring task is received.

Herein, the third collaborative authoring task may include one or more subtasks, the second authoring information may include a second execution content, the second execution content belongs to a target subtask in the one or more subtasks, and the target subtask is a subtask selected from the one or more subtasks by the second author.

Step 503, a fourth collaborative authoring task is generated and released according to the second authoring information and the third collaborative authoring task.

Herein, the fourth collaborative authoring task may include a fourth process task state diagram, the fourth process task state diagram may include one or more fourth process nodes and one or more fourth process user sites, and the one or more fourth process user sites belong to the one or more fourth process nodes. In addition, the one or more fourth process nodes may include the one or more third process nodes and a second execution content node corresponding to the second execution content; the one or more fourth process user sites include the one or more third process user sites and a user site corresponding to the second author; and the user site corresponding to the second author belongs to the second execution content node.

In some examples, each third process node includes a node identifier and each fourth process node includes a node identifier; each third process user site includes: a user identifier of a user corresponding to the third process user site and a node identifier of a third process node to which the third process user site belongs; and each fourth process user site includes: a user identifier of a user corresponding to the fourth process user site and a node identifier of a fourth process node to which the fourth process user site belongs.

In some other examples, the second execution content may include one or more subordinate subtasks; the one or more fourth process nodes may further include one or more subordinate subtask nodes corresponding to the one or more subordinate subtasks; and the fourth process task state diagram may further include an association relation between the one or more subordinate subtask nodes and the one or more fourth process user sites.

Illustratively, the association relation between one or more subordinate subtask nodes and one or more fourth process user sites may be determined in the following way: for at least one subordinate subtask node of the one or more subordinate subtask nodes, a fourth process user site associated with the at least one subordinate subtask node is determined in at least one of the following ways: the fourth process user site associated with the at least one subordinate subtask node is determined by direct assigning; and the fourth process user site associated with the at least one subordinate subtask node is determined by intelligent matching.

Illustratively, the subordinate subtask may include subtask description information. The step that the fourth process user site associated with the at least one subordinate subtask node is determined by intelligent matching may be implemented in the following way: processing is performed on each subordinate subtask node as follows: the subtask description information of a subordinate subtask corresponding to the subordinate subtask node is matched with the user description information corresponding to each of the plurality of users respectively, so as to obtain at least one user having a highest-ranking matching degree; and the fourth process user site associated with the subordinate subtask node is determined according to the at least one user having a highest-ranking matching degree.

In some other examples, the above collaborative authoring community may further include a current collaborative authoring task, where the current collaborative authoring task may include a current process task state diagram. Before the step that a fourth collaborative authoring task is generated and released according to the second authoring information and the third collaborative authoring task, the current collaborative authoring task is the third collaborative authoring task, the current process task state diagram is the third process task state diagram, a portion of subtask nodes of the one or more subtask nodes in the third process task state diagram are in an authorable state, and the target subtask is a subtask corresponding to a subtask node selected by the second author from the portion of subtask nodes that are in the authorable state. After the step that a fourth collaborative authoring task is generated and released according to the second authoring information and the third collaborative authoring task, the current collaborative authoring task becomes the fourth collaborative authoring task, and the current process task state diagram becomes the fourth process task state diagram.

In some examples, following the above instance, if the second authoring information is first authoring information, before the step that a fourth collaborative authoring task is generated and released according to the second authoring information and the third collaborative authoring task, the current collaborative authoring task is a first collaborative authoring task, the current process task state diagram is a first process task state diagram, a portion of subtask nodes of one or more subtask nodes in the first process task state diagram are in an authorable state, the target subtask is a subtask corresponding to a subtask node selected by a first author from the portion of subtask nodes that are in the authorable state, and the first collaborative authoring task is generated and released according to a preset collaborative authoring task and the user description information. After the step that a fourth collaborative authoring task is generated and released according to the second authoring information and the third collaborative authoring task, the current collaborative authoring task becomes a second collaborative authoring task, and the current process task state diagram becomes a second process task state diagram.

A process of initiating communication in a collaborative authoring community based on a current process task state diagram included in a current collaborative authoring task continues to be described below, where the collaborative authoring community may include a plurality of users.

Illustratively, with reference to FIG. 4C, a schematic flowchart of a method for initiating communication in a collaborative authoring community according to an example of the present disclosure is shown, and the method is described in conjunction with steps shown in FIG. 4C.

Step 601, a current collaborative authoring task is acquired.

Herein, the current collaborative authoring task may include a current process task state diagram, the current process task state diagram includes one or more current process nodes and one or more current process user sites, the one or more current process user sites belong to the one or more current process nodes, and the plurality of users include users corresponding to the one or more current process user sites.

In some examples, each user may include a corresponding user identifier; the current process node may include a node identifier; and the current process user site may include: a user identifier of a user corresponding to the current process user site and a node identifier of a current process node to which the current process user site belongs.

In some other examples, the one or more current process nodes may include a platform node, and the platform node is configured to provide management and/or a service for a platform.

Step 602, a receiver selected in the current process task state diagram by a third collaborative authoring community user is acquired.

In some examples, step 602 may be implemented in the following way: in response to a selection operation of selecting at least one current process node in the current process task state diagram by the third collaborative authoring community user, at least one current process user site associated with the selected at least one current process node is taken as the receiver.

Illustratively, the step that in response to a selection operation of selecting at least one current process node in the current process task state diagram by the third collaborative authoring community user, at least one current process user site associated with the selected at least one current process node is taken as the receiver may be implemented in the following way: in response to determining that the at least one current process node is selected in the current process task state diagram by the third collaborative authoring community user, all current process user sites associated with the selected at least one current process node are acquired; and in response to determining that at least one current process user site is selected from all the associated current process user sites by the current collaborative authoring community user, the selected at least one current process user site is taken as the receiver.

Illustratively, when the current process node to which a target user site belongs includes a subtask node, the step that in response to a selection operation of selecting at least one current process node in the current process task state diagram by the third collaborative authoring community user, at least one current process user site associated with the selected at least one current process node is taken as the receiver or may be implemented in the following way: in response to determining that a first subtask node is selected in the current process task state diagram by the third collaborative authoring community user, at least one communication action option associated with the first subtask node is acquired, where each communication action option corresponds to at least one subtask node; and in response to determining that a first communication action option is selected from the at least one communication action option by the third collaborative authoring community user, a current process user site associated with a subtask node corresponding to the first communication action option is taken as the receiver.

In some other examples, following the above instance, in response to determining that the first communication action option is selected from the at least one communication action option by the third collaborative authoring community user, the following processing may also be executed: the subtask node corresponding to the first communication action option is switched from a fifth scenario mode to a sixth scenario mode, so as to indicate that the subtask node corresponding to the first communication action option is currently in a selected state, where the sixth scenario mode is different from the fifth scenario mode.

Illustratively, when the current process node to which a target user site belongs includes an execution content node, the step that in response to a selection operation of selecting at least one current process node in the current process task state diagram by the third collaborative authoring community user, at least one current process user site associated with the selected at least one current process node is taken as the receiver or may be implemented in the following way: in response to determining that a first execution content node is selected in the current process task state diagram by the third collaborative authoring community user, at least one communication action option associated with the first execution content node is acquired, where each communication action option corresponds to at least one execution content node; and in response to determining that a second communication action option is selected from the at least one communication action option by the third collaborative authoring community user, a current process user site associated with the execution content node corresponding to the second communication action option is taken as the receiver.

In some other examples, following the above instance, in response to determining that the second communication action option is selected from the at least one communication action option by the third collaborative authoring community user, the following processing may also be executed: the execution content node corresponding to the second communication action option is switched from a seventh scenario mode to an eighth scenario mode, so as to indicate that the execution content node corresponding to the second communication action option is currently in a selected state, where the seventh scenario mode is different from the eighth scenario mode.

In some examples, when the current process node to which a target user site belongs includes a subtask node, step 602 or may be implemented in the following way: in response to a selection operation of selecting a first subtask node in the current process task state diagram by the third collaborative authoring community user, the first subtask node and each subtask node derived from the first subtask node are taken as target nodes, and current process user sites associated with the target nodes are taken as the receiver.

In some examples, when the current process node to which a target user site belongs includes a subtask node, step 602 or may be implemented in the following way: in response to a selection operation of selecting a first subtask node in the current process task state diagram by the third collaborative authoring community user, the first subtask node and each execution content node possessed by the first subtask node are taken as target nodes, and current process user sites associated with the target nodes are taken as the receiver.

In some examples, when the current process node to which a target user site belongs includes an execution content node, step 602 or may be implemented in the following way: in response to a selection operation of selecting a first execution content node in the current process task state diagram by the third collaborative authoring community user, the first execution content node and each execution content node derived from the first execution content node are taken as target nodes, and current process user sites associated with the target nodes are taken as the receiver.

In some examples, when the current process node to which a target user site belongs includes a framework type subtask node, step 602 or may be implemented in the following way: in response to a selection operation of selecting a first framework type subtask node in the current process task state diagram by the third collaborative authoring community user, the first framework type subtask node, each execution content node possessed by the first framework type subtask node, and all subordinate subtask nodes possessed by each execution content node are taken as target nodes, and current process user sites associated with the target nodes are taken as the receiver.

In some other examples, step 602 or may be implemented in the following way: in response to a selection operation of selecting at least one current process user site associated with any current process node in the current process task state diagram by the third collaborative authoring community user, the selected at least one current process user site is taken as the receiver.

It should be noted that a process of selecting the receiver in the current process task state diagram by the third collaborative authoring community user is similar to a process of selecting the receiver in the first process task state diagram by the first collaborative authoring community user or a process of selecting the receiver in the second process task state diagram by the second collaborative authoring community user, may be implemented with reference to the above, and thus will not be repeated herein in the examples of the present disclosure.

Step 603, communication to the receiver is initiated.

Herein, the receiver may include: one or more target user sites, where the one or more current process user sites include the one or more target user sites. In other words, the receiver may be a set of the one or more target user sites selected from the one or more current process user sites by the third collaborative authoring community user.

It can be seen that in the examples of the present disclosure, addressing information of the user site included in the receiver may include: user identity information of the user corresponding to the user site and a node identifier of the node to which the user site belongs in the task state diagram. The addressing information is configured to establish communication between the source and the receiver.

In some examples, when the source (i.e. the third collaborative authoring community user) is simultaneously associated with a plurality of current process nodes in the current process task state diagram, before the communication to the receiver is established, the following processing may also be executed: in response to determining that a first current process node in the current process task state diagram is triggered, the first current process node is taken as a node to which the source belongs in the current process task state diagram, where the plurality of current process nodes include the first current process node. For example, assuming that the third collaborative authoring community user is the task releaser and a subtask expert of one subtask, the third collaborative authoring community user is simultaneously associated with the task setting information node and one subtask node. In this case, the third collaborative authoring community user needs to make a selection. For example, assuming that the third collaborative authoring community user selects the subtask node in the current process task state diagram, the user site includes a node identifier of the subtask node, so as to indicate that a current identity of the third collaborative authoring community user is the subtask expert.

In other words, before the communication to the receiver is initiated, the following processing may also be executed: a user site corresponding to the third collaborative authoring community user (i.e. the source) is sent to the receiver. The user site corresponding to the third collaborative authoring community user includes: a user identifier of the third collaborative authoring community user and a node identifier of the current process node to which the third collaborative authoring community user belongs in the current process task state diagram. For example, when the third collaborative authoring community user is the task releaser, a user site of the task releaser may be sent to the receiver. The user site of the task releaser includes: an identifier of the task releaser and a node identifier of a task setting information node to which the task releaser belongs in the current process task state diagram.

In other words, according to the examples of the present disclosure, the addressing information of the source may be provided for the receiver, where the addressing information of the source includes node information of the node associated with the source in the task state diagram, in addition to identity information of the source. When a user corresponding to the source is simultaneously associated with a plurality of nodes in the task state diagram, node information of the node triggered (for example, the above first node) in the plurality of nodes may be provided for the receiver. When the source is associated with only one node in the task state diagram, node information of the node may be directly provided for the receiver. In this way, the receiver may understand the context more comprehensively when receiving the information. Moreover, when the receiver replies to the information received with new information, the addressing information of the source may be used as addressing information of the receiver replying with the new information. The addressing information of the receiver replying with the new information may further include node information of the node associated with the receiver replying with the new information in the task state diagram. Thus, a user site of the receiver replying with the new information is constituted.

It should be noted that in the examples of the present disclosure, node information of the node associated with the source in the task state diagram may be provided for the receiver. In other words, the addressing information of the source further includes user identity information of the source and the node information of the node associated with the source in the task state diagram. The addressing information of the source is provided for the receiver. Thus, when receiving the information sent from the source, the receiver may understand the source, background, and associated context of the information more comprehensively. Further, when the receiver replies to the information received with the new information, the receiver of the new information may include the node information of the node associated with the receiver of the new information in the task state diagram. Actually, the receiver of the new information is a sender of the information to be reply, i.e. the source of the information to be reply.

Illustratively, in the examples of the present disclosure, the addressing information of the source is the user identity information associated with the node in the task state diagram. It indicates that the addressing information of the source includes information in two aspects: the user identity information of the user site of the source, which is the traditional addressing information; and the node information to which the user site of the source belongs, where the node belongs to one task state diagram, and the one task state diagram belongs to one collaborative authoring task. It indicates that before initiating the communication, the source should select the node to which the user site of the source belongs in the task state diagram in the present communication process. In other words, in the examples of the present disclosure, the node information of the node associated with the source in the task state diagram is provided for the receiver. Thus, more complete context information of the task progress is offered to the communication process in the scenario.

In the method for initiating communication in a collaborative authoring community according to the examples of the present disclosure, the addressing information of the users in the task group may be provided for the other users in the task group in a multipoint-to-multipoint manner based on the task state diagram according to collaborative authoring procedure management rules. Moreover, the node information of the node associated with the source in the task state diagram may also be provided for the receiver as one of the contents of the addressing information of the source. Thus, the communication environment that is closely integrated with the collaborative authoring procedures and seamlessly connected with the collaborative authoring behaviors can be offered to the collaborative authors.

An illustrative structure of an apparatus 543 for releasing a collaborative authoring task in a collaborative authoring community according to the examples of the present disclosure and implemented as a software module continues to be described below. In some examples, as shown in FIG. 2A, the software module of the apparatus 543 for releasing a collaborative authoring task in a collaborative authoring community stored in a memory 540 may include: an acquisition module 5431 and a release module 5432.

In some examples, the collaborative authoring community includes a plurality of users, where each user includes a user identifier and user description information. The acquisition module 5431 is configured to acquire a preset collaborative authoring task, where the preset collaborative authoring task includes a preset task state diagram, and the preset task state diagram includes one or more subtask nodes. The release module 5432 is configured to generate and release a first collaborative authoring task according to the preset collaborative authoring task and the user description information, where the first collaborative authoring task includes a first process task state diagram, the first process task state diagram includes one or more first process nodes and one or more first process user sites, and the one or more first process user sites belong to the one or more first process nodes; and the plurality of users include users corresponding to the one or more first process user sites, and the one or more first process nodes include the one or more subtask nodes.

In some examples, each first process node includes a node identifier; and each first process user site includes: a user identifier of a user corresponding to the first process user site and a node identifier of a first process node to which the first process user site belongs.

In some examples, the one or more first process nodes further include a platform node, and the platform node is configured to provide management and/or service for a platform.

In some examples, the apparatus 543 for releasing a collaborative authoring task in a collaborative authoring community further includes a determination module 5435. Before the first collaborative authoring task is released, for at least one first process node of the one or more first process nodes, the determination module is configured to determine a first process user site associated with the at least one first process node in at least one of the following ways of determining the first process user site associated with the at least one first process node by direct assigning; and determining the first process user site associated with the at least one first process node by intelligent matching.

In some examples, the preset collaborative authoring task includes one or more subtasks, and each subtask includes subtask description information. When at least one first process node is at least one subtask node, for each subtask node, the determination module 5435 is further configured to execute the following processing of matching the subtask description information of a subtask corresponding to the subtask node with the user description information of each of the plurality of users, so as to obtain at least one user having a highest-ranking matching degree; and determining the first process user site associated with the subtask node according to the at least one user having a highest-ranking matching degree.

An illustrative structure of an apparatus 543 for releasing a collaborative authoring task in a collaborative authoring community according to the examples of the present disclosure and implemented as a software module continues to be described below. In some examples, as shown in FIG. 2A, the software module of the apparatus 543 for releasing a collaborative authoring task in a collaborative authoring community stored in a memory 540 may include: a sending module 5433, a reception module 5434, and a release module 5432.

In some examples, the collaborative authoring community includes a plurality of users, where each user includes a user identifier and user description information. The sending module 5433 is configured to send a first collaborative authoring task, where the first collaborative authoring task includes a first process task state diagram, the first process task state diagram includes one or more first process nodes and one or more first process user sites, and the one or more first process user sites belong to the one or more first process nodes. The reception module 5434 is configured to receive first authoring information of a first author for the first collaborative authoring task, where the first collaborative authoring task includes one or more subtasks, the first authoring information includes a first execution content, the first execution content belongs to a target subtask in the one or more subtasks, and the target subtask is a subtask selected from the one or more subtasks by the first author. The release module 5432 is further configured to generate and release a second collaborative authoring task according to the first authoring information and the first collaborative authoring task, where the second collaborative authoring task includes a second process task state diagram, the second process task state diagram includes one or more second process nodes and one or more second process user sites, and the one or more second process user sites belong to the one or more second process nodes.

In some examples, the one or more first process nodes include a platform node, and the platform node is configured to provide management and/or service for a platform.

In some examples, the one or more second process nodes include the one or more first process nodes and a first execution content node corresponding to the first execution content; the one or more second process user sites include the one or more first process user sites and a user site corresponding to the first author; and the user site corresponding to the first author belongs to the first execution content node.

In some examples, each first process node includes a node identifier and each second process node includes a node identifier; each first process user site includes: a user identifier of a user corresponding to the first process user site and a node identifier of a first process node to which the first process user site belongs; and each second process user site includes: a user identifier of a user corresponding to the second process user site and a node identifier of a second process node to which the second process user site belongs.

In some examples, the first execution content includes one or more subordinate subtasks; the one or more second process nodes further include one or more subordinate subtask nodes corresponding to the one or more subordinate subtasks; and the second process task state diagram further includes an association relation between the one or more subordinate subtask nodes and the one or more second process user sites.

In some examples, the apparatus 543 for releasing a collaborative authoring task in a collaborative authoring community further includes a determination module 5435. For at least one subordinate subtask node of the one or more subordinate subtask nodes, the determination module is configured to determine a second process user site associated with the at least one subordinate subtask node in at least one of the following ways of determining the second process user site associated with the at least one subordinate subtask node by direct assigning; and determining the second process user site associated with the at least one subordinate subtask node by intelligent matching.

In some examples, each of the subordinate subtasks includes subtask description information. For each subordinate subtask node, the determination module 5435 is further configured to execute the following processing of matching the subtask description information of a subordinate subtask corresponding to the subordinate subtask node with the user description information of each of the plurality of users, so as to obtain at least one user having a highest-ranking matching degree; and determining the second process user site associated with the subordinate subtask node according to the at least one user having a highest-ranking matching degree.

An illustrative structure of an apparatus 543 for releasing a collaborative authoring task in a collaborative authoring community according to the examples of the present disclosure and implemented as a software module continues to be described below. In some examples, as shown in FIG. 2A, the software module of the apparatus 543 for releasing a collaborative authoring task in a collaborative authoring community stored in a memory 540 may include: a sending module 5433, a reception module 5434, and a release module 5432.

In some examples, the collaborative authoring community includes a plurality of users, where each user includes a user identifier and user description information. The sending module 5433 is configured to send a third collaborative authoring task, where the third collaborative authoring task includes a third process task state diagram, the third process task state diagram includes one or more third process nodes and one or more third process user sites, the one or more third process user sites belong to the one or more third process nodes, and the plurality of users include users corresponding to the one or more third process user sites. The reception module 5434 is configured to receive second authoring information of a second author for the third collaborative authoring task, where the third collaborative authoring task includes one or more subtasks, the second authoring information includes a second execution content, the second execution content belongs to a target subtask in the one or more subtasks, and the target subtask is a subtask selected from the one or more subtasks by the second author. The release module 5432 is configured to generate and release a fourth collaborative authoring task according to the second authoring information and the third collaborative authoring task, where the fourth collaborative authoring task includes a fourth process task state diagram, the fourth process task state diagram includes one or more fourth process nodes and one or more fourth process user sites, and the one or more fourth process user sites belong to the one or more fourth process nodes.

In some examples, the one or more third process nodes include a platform node, and the platform node is configured to provide management and/or service for a platform.

In addition, the one or more fourth process nodes include the one or more third process nodes and a second execution content node corresponding to the second execution content; the one or more fourth process user sites include the one or more third process user sites and a user site corresponding to the second author; and the user site corresponding to the second author belongs to the second execution content node.

In some examples, each third process node includes a node identifier and each fourth process node includes a node identifier; each third process user site includes: a user identifier of a user corresponding to the third process user site and a node identifier of a third process node to which the third process user site belongs; and each fourth process user site includes: a user identifier of a user corresponding to the fourth process user site and a node identifier of a fourth process node to which the fourth process user site belongs.

In some examples, the second execution content includes one or more subordinate subtasks; the one or more fourth process nodes further include one or more subordinate subtask nodes corresponding to the one or more subordinate subtasks; and the fourth process task state diagram further includes an association relation between the one or more subordinate subtask nodes and the one or more fourth process user sites.

In some examples, the apparatus 543 for releasing a collaborative authoring task in a collaborative authoring community further includes a determination module 5435. For at least one subordinate subtask node of the one or more subordinate subtask nodes, the determination module is configured to determine a fourth process user site associated with the at least one subordinate subtask node in at least one of the following ways of determining the fourth process user site associated with the at least one subordinate subtask node by direct assigning; and determining the fourth process user site associated with the at least one subordinate subtask node by intelligent matching.

In some examples, each of the subordinate subtasks includes subtask description information. For each subordinate subtask node, the determination module 5435 is further configured to execute the following processing of matching the subtask description information of a subordinate subtask corresponding to the subordinate subtask node with the user description information of each of the plurality of users, so as to obtain at least one user having a highest-ranking matching degree; and determining the fourth process user site associated with the subordinate subtask node according to the at least one user having a highest-ranking matching degree.

In some examples, the collaborative authoring community further includes a current collaborative authoring task, where the current collaborative authoring task includes a current process task state diagram. Before the fourth collaborative authoring task is generated and released according to the second authoring information and the third collaborative authoring task, the current collaborative authoring task is the third collaborative authoring task, the current process task state diagram is the third process task state diagram, a portion of subtask nodes of the one or more subtask nodes in the third process task state diagram are in an authorable state, and the target subtask is a subtask corresponding to a subtask node selected by the second author from the portion of subtask nodes that are in the authorable state. After the fourth collaborative authoring task is generated and released according to the second authoring information and the third collaborative authoring task, the current collaborative authoring task becomes the fourth collaborative authoring task, and the current process task state diagram becomes the fourth process task state diagram.

In some examples, if the second authoring information is first authoring information, before the fourth collaborative authoring task is generated and released according to the second authoring information and the third collaborative authoring task, the current collaborative authoring task is a first collaborative authoring task, the current process task state diagram is a first process task state diagram, a portion of subtask nodes of one or more subtask nodes in the first process task state diagram are in an authorable state, the target subtask is a subtask corresponding to a subtask node selected by a first author from the portion of subtask nodes that are in the authorable state, and the first collaborative authoring task is generated and released according to a preset collaborative authoring task and the user description information. After the fourth collaborative authoring task is generated and released according to the second authoring information and the third collaborative authoring task, the current collaborative authoring task becomes a second collaborative authoring task, and the current process task state diagram becomes a second process task state diagram.

An illustrative structure of an apparatus 655 for initiating communication in a collaborative authoring community according to the examples of the present disclosure and implemented as a software module continues to be described below. In some examples, as shown in FIG. 2B, the software module of the apparatus 655 for initiating communication in a collaborative authoring community stored in a memory 650 may include: an acquisition module 6551 and a communication module 6552.

In some examples, the collaborative authoring community includes a plurality of users. The acquisition module 6551 is configured to acquire a first collaborative authoring task, where the first collaborative authoring task includes a first process task state diagram, the first process task state diagram includes one or more first process nodes and one or more first process user sites, the one or more first process user sites belong to the one or more first process nodes, and the plurality of users include users corresponding to the one or more first process user sites. The acquisition module 6551 is further configured to acquire a receiver selected in the first process task state diagram by a first collaborative authoring community user. The communication module 6552 is configured to initiate communication to the receiver, where the receiver includes one or more target user sites, and the one or more first process user sites include the one or more target user sites.

In some examples, each user includes a user identifier; each first process node includes a node identifier; and each first process user site includes: a user identifier of a user corresponding to the first process user site and a node identifier of a first process node to which the first process user site belongs.

In some examples, the one or more first process nodes include a platform node, and the platform node is configured to provide management and/or service for a platform.

In some examples, the acquisition module 6551 is further configured to take, in response to a selection operation of selecting at least one first process node in the first process task state diagram by the first collaborative authoring community user, at least one first process user site associated with the selected at least one first process node as the receiver.

In some examples, the acquisition module 6551 is further configured to acquire, in response to determining that the at least one first process node is selected in the first process task state diagram by the first collaborative authoring community user, all first process user sites associated with the at least one first process node; and take, in response to determining that at least one first process user site is selected from all the associated first process user sites by the first collaborative authoring community user, the selected at least one first process user site as the receiver.

In some examples, when the first process node to which the target user site belongs includes a subtask node, the acquisition module 6551 is further configured to acquire, in response to determining that a first subtask node is selected in the first process task state diagram by the first collaborative authoring community user, at least one communication action option associated with the first subtask node, where each communication action option corresponds to at least one subtask node; and take, in response to determining that a first communication action option is selected from the at least one communication action option by the first collaborative authoring community user, at least one first process user site associated with a subtask node corresponding to the first communication action option as the receiver.

In some examples, the apparatus 655 for initiating communication in a collaborative authoring community further includes a switch module 6553. The switch module is configured to switch, in response to determining that the first communication action option is selected from the at least one communication action option by the first collaborative authoring community user, the subtask node corresponding to the first communication action option from a first scenario mode to a second scenario mode, so as to indicate that the subtask node corresponding to the first communication action option is currently in a selected state, where the second scenario mode is different from the first scenario mode.

In some examples, when the first process node to which the target user site belongs includes a subtask node, the acquisition module 6551 is further configured to take, in response to a selection operation of selecting a first subtask node in the first process task state diagram by the first collaborative authoring community user, the first subtask node and each subtask node derived from the first subtask node as target nodes, and take first process user sites associated with the target nodes as the receiver.

In some examples, the acquisition module 6551 is further configured to take, in response to a selection operation of selecting at least one first process user site associated with any first process node in the first process task state diagram by the first collaborative authoring community user, the selected at least one first process user site as the receiver.

In some examples, the communication module 6542 is further configured to send a user site corresponding to the first collaborative authoring community user to the receiver, where the user site corresponding to the first collaborative authoring community user includes: a user identifier of the first collaborative authoring community user and a node identifier of a first process node to which the first collaborative authoring community user belongs in the first process task state diagram. An illustrative structure of an apparatus 655 for initiating communication in a collaborative authoring community according to the examples of the present disclosure and implemented as a software module continues to be described below. In some examples, as shown in FIG. 2B, the software module of the apparatus 655 for initiating communication in a collaborative authoring community stored in a memory 650 may include: an acquisition module 6551 and a communication module 6552.

In some examples, the collaborative authoring community includes a plurality of users. The acquisition module 6551 is configured to acquire a second collaborative authoring task, where the second collaborative authoring task includes a second process task state diagram, the second process task state diagram includes one or more second process nodes and one or more second process user sites, the one or more second process user sites belong to the one or more second process nodes, and the plurality of users include users corresponding to the one or more second process user sites. The acquisition module 6551 is further configured to acquire a receiver selected in the second process task state diagram by a second collaborative authoring community user. The communication module 6552 is configured to initiate communication to the receiver, where the receiver includes: one or more target user sites, and the one or more second process user sites include the one or more target user sites.

In some examples, each user includes a user identifier; each second process node includes a node identifier; and each second process user site includes: a user identifier of a user corresponding to the second process user site and a node identifier of a second process node to which the second process user site belongs.

In some examples, the one or more second process nodes further include a platform node, and the platform node is configured to provide management and/or service for a platform.

In some examples, the acquisition module 6551 is further configured to take, in response to a selection operation of selecting at least one second process node in the second process task state diagram by the second collaborative authoring community user, at least one second process user site associated with the selected at least one second process node as the receiver.

In some examples, the acquisition module 6551 is further configured to acquire, in response to determining that the at least one second process node is selected in the second process task state diagram by the second collaborative authoring community user, all second process user sites associated with the at least one second process node; and take, in response to determining that at least one second process user site is selected from all the associated second process user sites by the second collaborative authoring community user, the selected at least one second process user site as the receiver.

In some examples, when the second process node to which the target user site belongs includes an execution content node, the acquisition module 6551 is further configured to acquire, in response to determining that a first execution content node is selected in the second process task state diagram by the second collaborative authoring community user, at least one communication action option associated with the first execution content node, where each communication action option corresponds to at least one execution content node; and take, in response to determining that a second communication action option is selected from the at least one communication action option by the second collaborative authoring community user, at least one second process user site associated with an execution content node corresponding to the second communication action option as the receiver.

In some examples, the apparatus 655 for initiating communication in a collaborative authoring community further includes a switch module 6553. The switch module is configured to switch, in response to determining that the second communication action option is selected from the at least one communication action option by the second collaborative authoring community user, the execution content node corresponding to the second communication action option from a third scenario mode to a fourth scenario mode, so as to indicate that the execution content node corresponding to the second communication action option is currently in a selected state, where the third scenario mode is different from the fourth scenario mode.

In some examples, when the second process node to which the target user site belongs includes a subtask node, the acquisition module 6551 is further configured to take, in response to a selection operation of selecting a first subtask node in the second process task state diagram by the second collaborative authoring community user, the first subtask node and each execution content node possessed by the first subtask node as target nodes, and take second process user sites associated with the target nodes as the receiver.

In some examples, when the second process node to which the target user site belongs includes an execution content node, the acquisition module 6551 is further configure to take, in response to a selection operation of selecting a first execution content node in the second process task state diagram by the second collaborative authoring community user, the first execution content node and each execution content node derived from the first execution content node as target nodes, and take second process user sites associated with the target nodes as the receiver.

In some examples, when the second process node to which the target user site belongs includes a framework type subtask node, the acquisition module 6551 is further configured to take, in response to a selection operation of selecting a first framework type subtask node in the second process task state diagram by the second collaborative authoring community user, the first framework type subtask node, each execution content node possessed by the first framework type subtask node, and all subordinate subtask nodes possessed by each execution content node as target nodes, and take second process user sites associated with the target nodes as the receiver.

In some examples, when the second process node to which the target user site belongs includes a subtask node, the acquisition module 6551 is further configured to take, in response to a selection operation of selecting a first subtask node in the second process task state diagram by the second collaborative authoring community user, the first subtask node and each subtask node derived from the first subtask node as target nodes, and take second process user sites associated with the target nodes as the receiver.

In some examples, the acquisition module 6551 is further configured to take, in response to a selection operation of selecting at least one second process user site associated with any second process node in the second process task state diagram by the second collaborative authoring community user, the selected at least one second process user site as the receiver.

In some examples, the communication module 6542 is further configured to send a user site corresponding to the second collaborative authoring community user to the receiver, where the user site corresponding to the second collaborative authoring community user includes: a user identifier of the second collaborative authoring community user and a node identifier of a second process node to which the second collaborative authoring community user belongs in the second process task state diagram. An illustrative structure of an apparatus 655 for initiating communication in a collaborative authoring community according to the examples of the present disclosure and implemented as a software module continues to be described below. In some examples, as shown in FIG. 2B, the software module of the apparatus 655 for initiating communication in a collaborative authoring community stored in a memory 650 may include: an acquisition module 6551 and a communication module 6552.

In some examples, the collaborative authoring community includes a plurality of users. The acquisition module 6551 is configured to acquire a current collaborative authoring task, where the current collaborative authoring task includes a current process task state diagram, the current process task state diagram includes one or more current process nodes and one or more current process user sites, the one or more current process user sites belong to the one or more current process nodes, and the plurality of users include users corresponding to the one or more current process user sites. The acquisition module 6551 is further configured to acquire a receiver selected in the current process task state diagram by a third collaborative authoring community user. The communication module 6552 is configured to initiate communication to the receiver, where the receiver includes: one or more target user sites, and the one or more current process user sites include the one or more target user sites.

In some examples, each user includes a user identifier; each current process node includes a node identifier; and each current process user site includes: a user identifier of a user corresponding to the current process user site and a node identifier of a current process node to which the current process user site belongs.

In some examples, the one or more current process nodes include a platform node, and the platform node is configured to provide management and/or service for a platform.

In some examples, the acquisition module 6551 is further configured to take, in response to a selection operation of selecting at least one current process node in the current process task state diagram by the third collaborative authoring community user, at least one current process user site associated with the selected at least one current process node as the receiver.

In some examples, the acquisition module 6551 is further configured to acquire, in response to determining that the at least one current process node is selected in the current process task state diagram by the third collaborative authoring community user, all current process user sites associated with the at least one current process node; and take, in response to determining that at least one current process user site is selected from all the associated current process user sites by the third collaborative authoring community user, the selected at least one current process user site as the receiver.

In some examples, when the current process node to which the target user site belongs includes a subtask node, the acquisition module 6551 is further configured to acquire, in response to determining that a first subtask node is selected in the current process task state diagram by the third collaborative authoring community user, at least one communication action option associated with the first subtask node, where each communication action option corresponds to at least one subtask node; and take, in response to determining that a first communication action option is selected from the at least one communication action option by the third collaborative authoring community user, a current process user site associated with a subtask node corresponding to the first communication action option as the receiver.

In some examples, the apparatus 655 for initiating communication in a collaborative authoring community further includes a switch module 6553. The switch module is configured to switch, in response to determining that the first communication action option is selected from the at least one communication action option by the third collaborative authoring community user, the subtask node corresponding to the first communication action option from a fifth scenario mode to a sixth scenario mode, so as to indicate that the subtask node corresponding to the first communication action option is currently in a selected state, where the sixth scenario mode is different from the fifth scenario mode.

In some examples, when the current process node to which the target user site belongs includes an execution content node, the acquisition module 6551 is further configured to acquire, in response to determining that a first execution content node is selected in the current process task state diagram by the third collaborative authoring community user, at least one communication action option associated with the first execution content node, where each communication action option corresponds to at least one execution content node; and take, in response to determining that a second communication action option is selected from the at least one communication action option by the third collaborative authoring community user, a current process user site associated with an execution content node corresponding to the second communication action option as the receiver.

In some examples, the switch module 6553 is further configured to switch, in response to determining that the second communication action option is selected from the at least one communication action option by the third collaborative authoring community user, the execution content node corresponding to the second communication action option from a seventh scenario mode to an eighth scenario mode, so as to indicate that the execution content node corresponding to the second communication action option is currently in a selected state, where the seventh scenario mode is different from the eighth scenario mode.

In some examples, when the current process node to which the target user site belongs includes a subtask node, the acquisition module 6551 is further configured to take, in response to a selection operation of selecting a first subtask node in the current process task state diagram by the third collaborative authoring community user, the first subtask node and each subtask node derived from the first subtask node as target nodes, and take current process user sites associated with the target nodes as the receiver.

In some examples, when the current process node to which the target user site belongs includes a subtask node, the acquisition module 6551 is further configured to take, in response to a selection operation of selecting a first subtask node in the current process task state diagram by the third collaborative authoring community user, the first subtask node and each execution content node possessed by the first subtask node as target nodes, and take current process user sites associated with the target nodes as the receiver.

In some examples, when the current process node to which the target user site belongs includes an execution content node, the acquisition module 6551 is further configure to take, in response to a selection operation of selecting a first execution content node in the current process task state diagram by the third collaborative authoring community user, the first execution content node and each execution content node derived from the first execution content node as target nodes, and take current process user sites associated with the target nodes as the receiver.

In some examples, when the current process node to which the target user site belongs includes a framework type subtask node, the acquisition module 6551 is further configured to take, in response to a selection operation of selecting a first framework type subtask node in the current process task state diagram by the third collaborative authoring community user, the first framework type subtask node, each execution content node possessed by the first framework type subtask node, and all subordinate subtask nodes possessed by each execution content node as target nodes, and take current process user sites associated with the target nodes as the receiver.

In some examples, the acquisition module 6551 is further configured to take, in response to a selection operation of selecting at least one current process user site associated with any current process node in the current process task state diagram by the third collaborative authoring community user, the selected at least one current process user site as the receiver.

In some examples, the communication module 6542 is further configured to send a user site corresponding to the third collaborative authoring community user to the receiver, where the user site corresponding to the third collaborative authoring community user includes: a user identifier of the third collaborative authoring community user and a node identifier of a current process node to which the third collaborative authoring community user belongs in the current process task state diagram.

It should be noted that the description of the apparatus according to the examples of the present disclosure is similar to that of the above method example, indicating that the apparatus has similar beneficial effects to those of the method examples, and thus will not be repeated. The technical details not described in the apparatus for releasing a collaborative authoring task in a collaborative authoring community or the apparatus for initiating communication in a collaborative authoring community according to the examples of the present disclosure can be understood according to the description in any one of FIGS. 3A, 3B, 3C, 4A, 4B, and 4C.

A computer-readable storage medium having computer-executable instructions stored therein is provided in the examples of the present disclosure. The computer-readable storage medium has the computer-executable instructions stored therein. The computer-executable instructions, when executed by a processor, cause the processor to execute the method for releasing a collaborative authoring task in a collaborative authoring community or the method for initiating communication in a collaborative authoring community according to the examples of the present disclosure, for example, the method for releasing a collaborative authoring task in a collaborative authoring community shown in FIG. 3A. 3B, or 3C, or the method for initiating communication in a collaborative authoring community shown in FIG. 4A, 4B, or 4C.

In some examples, the computer-readable storage medium may be a ferroelectric random access memory (FRAM), a read only memory (ROM), a programmable read only memory (PROM), an erasable programmable read only memory (EPROM), an electrically erasable programmable read only memory (EEPROM), a flash memory, a magnetic surface memory, an optical disk, or a compact disk read only memory (CD-ROM); or various devices including one or any combination of the above memories.

In some examples, the executable instructions may take the form of programs, software, software modules, scripts, or codes, written in any form of programming language (including a compiled or interpreted language and a declarative or procedural language), and deployed in any form, such as stand-alone programs, modules, components, sub-routines, and other units suitable for use in a computation environment.

As an instance, the executable instructions may be deployed to be executed in one electronic device, a plurality of electronic devices located at one place, or a plurality of electronic devices distributed at a plurality of places and interconnected through a communication network.

What are described above are merely the examples of the present disclosure, but are not intended to limit the scope of protection of the present disclosure. Any modifications, equivalent replacements, improvements, etc. made within the spirit and scope of the present disclosure should fall within the scope of protection of the present disclosure.

1-23. (canceled)

24. A method for initiating communication in a collaborative authoring community, performed by an electronic device; wherein the collaborative authoring community comprises a plurality of users; and
the method comprises:
acquiring a current collaborative authoring task, wherein the current collaborative authoring task comprises a current process task state diagram, the current process task state diagram comprises one or more current process nodes and one or more current process user sites, the one or more current process user sites belong to the one or more current process nodes, and the plurality of users include users corresponding to the one or more current process user sites;
acquiring a receiver selected in the current process task state diagram by a third collaborative authoring community user; and
initiating communication to the receiver, wherein the receiver comprises: one or more target user sites, and the one or more current process user sites include the one or more target user sites.

25. The method according to claim 24, wherein
each user comprises a user identifier;
each current process node comprises a node identifier; and
each current process user site comprises: a user identifier of a user corresponding to the current process user site and a node identifier of a current process node to which the current process user site belongs.

26. (canceled)

27. The method according to claim 24, wherein the step of acquiring a receiver selected in the current process task state diagram by a third collaborative authoring community user comprises:
in response to a selection operation of selecting at least one current process node in the current process task state diagram by the third collaborative authoring community user, taking at least one current process user site associated with the selected at least one current process node as the receiver.

28. The method according to claim 27, wherein the step of, in response to a selection operation of selecting at least one current process node in the current process task state diagram by the third collaborative authoring community user, taking at least one current process user site associated with the selected at least one current process node as the receiver comprises:
in response to determining that the at least one current process node is selected in the current process task state diagram by the third collaborative authoring community user, acquiring all current process user sites associated with the selected at least one current process node; and
in response to determining that at least one current process user site is selected from all the associated current process user sites by the third collaborative authoring community user, taking the selected at least one current process user site as the receiver.

29. The method according to claim 27, wherein
when the current process node to which the target user site belongs comprises a subtask node, the step of, in response to a selection operation of selecting at least one current process node in the current process task state diagram by the third collaborative authoring community user, taking at least one current process user site associated with the selected at least one current process node as the receiver comprises:
in response to determining that a first subtask node is selected in the current process task state diagram by the third collaborative authoring community user, acquiring at least one communication action option associated with the first subtask node, wherein each communication action option corresponds to at least one subtask node; and
in response to determining that a first communication action option is selected from the at least one communication action option by the third collaborative authoring community user, taking a current process user site associated with a subtask node corresponding to the first communication action option as the receiver.

30. The method according to claim 29, wherein, in response to determining that the first communication action option is selected from the at least one communication action option by the third collaborative authoring community user, the method further comprises:
switching the subtask node corresponding to the first communication action option from a fifth scenario mode to a sixth scenario mode, so as to indicate that the subtask node corresponding to the first communication action option is currently in a selected state, wherein the sixth scenario mode is different from the fifth scenario mode.

31. The method according to claim 27, wherein
when the current process node to which the target user site belongs comprises an execution content node, the step of, in response to a selection operation of selecting at least one current process node in the current process task state diagram by the third collaborative authoring community user, taking at least one current process user site associated with the selected at least one current process node as the receiver comprises:
in response to determining that a first execution content node is selected in the current process task state diagram by the third collaborative authoring community user, acquiring at least one communication action option associated with the first execution content node, wherein each communication action option corresponds to at least one execution content node; and
in response to determining that a second communication action option is selected from the at least one communication action option by the third collaborative authoring community user, taking a current process user site associated with an execution content node corresponding to the second communication action option as the receiver.

32. The method according to claim 31, wherein, in response to determining that the second communication action option is selected from the at least one communication action option by the third collaborative authoring community user, the method further comprises:
switching the execution content node corresponding to the second communication action option from a seventh scenario mode to an eighth scenario mode, so as to indicate that the execution content node corresponding to the second communication action option is currently in a selected state, wherein the seventh scenario mode is different from the eighth scenario mode.

33. (canceled)

34. The method according to claim 24, wherein
when the current process node to which the target user site belongs comprises a subtask node, the step of acquiring a receiver selected in the current process task state diagram by a third collaborative authoring community user comprises:
in response to a selection operation of selecting a first subtask node in the current process task state diagram by the third collaborative authoring community user, taking the first subtask node and each execution content node possessed by the first subtask node as target nodes, and taking current process user sites associated with the target nodes as the receiver.

35. (canceled)

36. The method according to claim 24, wherein
when the current process node to which the target user site belongs comprises a framework type subtask node, the step of acquiring a receiver selected in the current process task state diagram by a third collaborative authoring community user comprises:
in response to a selection operation of selecting a first framework type subtask node in the current process task state diagram by the third collaborative authoring community user, taking the first framework type subtask node, each execution content node possessed by the first framework type subtask node, and each subordinate subtask node possessed by each execution content node as target nodes, and taking current process user sites associated with the target nodes as the receiver.

37. The method according to claim 24, wherein the step of acquiring a receiver selected in the current process task state diagram by a third collaborative authoring community user comprises:
in response to a selection operation of selecting at least one current process user site associated with any current process node in the current process task state diagram by the third collaborative authoring community user, taking the selected at least one current process user site as the receiver.

38. The method according to claim 24, further comprising:
sending a user site corresponding to the third collaborative authoring community user to the receiver, wherein the user site corresponding to the third collaborative authoring community user comprises: a user identifier of the third collaborative authoring community user and a node identifier of a current process node to which the third collaborative authoring community user belongs in the current process task state diagram.

39-50. (canceled)

51. A method for releasing a collaborative authoring task in a collaborative authoring community, performed by an electronic device; wherein the collaborative authoring community comprises a plurality of users, and each of the users comprises a user identifier and user description information; and
the method comprises:
sending a third collaborative authoring task, wherein the third collaborative authoring task comprises a third process task state diagram, the third process task state diagram comprises one or more third process nodes and one or more third process user sites, the one or more third process user sites belong to the one or more third process nodes, and the plurality of users include users corresponding to the one or more third process user sites;
receiving second authoring information of a second author for the third collaborative authoring task, wherein the third collaborative authoring task comprises one or more subtasks, the second authoring information comprises a second execution content, the second execution content belongs to a target subtask in the one or more subtasks, and the target subtask is a subtask selected from the one or more subtasks by the second author; and
generating and releasing a fourth collaborative authoring task according to the second authoring information and the third collaborative authoring task, wherein the fourth collaborative authoring task comprises a fourth process task state diagram, the fourth process task state diagram comprises one or more fourth process nodes and one or more fourth process user sites, and the one or more fourth process user sites belong to the one or more fourth process nodes.

52. (canceled)

53. The method according to claim 51, wherein
the one or more fourth process nodes comprise the one or more third process nodes and a second execution content node corresponding to the second execution content; the one or more fourth process user sites comprise the one or more third process user sites and a user site corresponding to the second author; and the user site corresponding to the second author belongs to the second execution content node.

54. The method according to claim 51, wherein
each third process node comprises a node identifier and each fourth process node comprises a node identifier;
each third process user site comprises: a user identifier of a user corresponding to the third process user site and a node identifier of a third process node to which the third process user site belongs; and
each fourth process user site comprises: a user identifier of a user corresponding to the fourth process user site and a node identifier of a fourth process node to which the fourth process user site belongs.

55. The method according to claim 51, wherein the second execution content comprises one or more subordinate subtasks; the one or more fourth process nodes further comprise one or more subordinate subtask nodes corresponding to the one or more subordinate subtasks; and the fourth process task state diagram further comprises an association relation between the one or more subordinate subtask nodes and the one or more fourth process user sites.

56. The method according to claim 55, further comprising:
for at least one subordinate subtask node of the one or more subordinate subtask nodes, determining a fourth process user site associated with the at least one subordinate subtask node in at least one of the following ways:
determining the fourth process user site associated with the at least one subordinate subtask node by direct assigning;
determining the fourth process user site associated with the at least one subordinate subtask node by intelligent matching,
wherein each of the subordinate subtask nodes comprises subtask description information; and
the step of determining the fourth process user site associated with the at least one subordinate subtask node by intelligent matching comprises:
performing processing on each subordinate subtask node as follows:
matching the subtask description information of a subordinate subtask corresponding to the subordinate subtask node with the user description information of each of the plurality of users, so as to obtain at least one user having a highest-ranking matching degree; and
determining a fourth process user site associated with the subordinate subtask node according to the at least one user having a highest-ranking matching degree.

57. (canceled)

58. The method according to claim 51, wherein the collaborative authoring community further comprises a current collaborative authoring task, and the current collaborative authoring task comprises a current process task state diagram;
before the step of generating and releasing a fourth collaborative authoring task according to the second authoring information and the third collaborative authoring task, the current collaborative authoring task is the third collaborative authoring task, the current process task state diagram is the third process task state diagram, a portion of subtask nodes of the one or more subtask nodes in the third process task state diagram are in an authorable state, the target subtask is a subtask corresponding to a subtask node selected by the second author from the portion of subtask nodes that are in the authorable state; and
after the step of generating and releasing a fourth collaborative authoring task according to the second authoring information and the third collaborative authoring task, the current collaborative authoring task becomes the fourth collaborative authoring task, and the current process task state diagram becomes the fourth process task state diagram.

59. The method according to claim 58, wherein
if the second authoring information is first authoring information, before the step of generating and releasing a fourth collaborative authoring task according to the second authoring information and the third collaborative authoring task, the current collaborative authoring task is a first collaborative authoring task, and the current process task state diagram is a first process task state diagram; a portion of subtask nodes of one or more subtask nodes in the first process task state diagram are in an authorable state; the target subtask is a subtask corresponding to a subtask node selected by a first author from the portion of subtask nodes that are in the authorable state; and the first collaborative authoring task is generated and released according to a preset collaborative authoring task and the user description information; and
after the step of generating and releasing a fourth collaborative authoring task according to the second authoring information and the third collaborative authoring task, the current collaborative authoring task becomes a second collaborative authoring task, and the current process task state diagram becomes a second process task state diagram.

60-65. (canceled)

66. An electronic device, comprising:
a memory configured to store executable instructions; and
a processor configured to execute the executable instructions stored in the memory, so as to implement the method for initiating communication in a collaborative authoring community according to claim 24.

67. (canceled)
